(19) United States
(12) Patent Application Publication
(10) Pub. No.: US 2010/0115172 A1
(43) Pub. Date: May 6, 2010

(54) BRIDGE DEVICE HAVING A VIRTUAL PAGE BUFFER

(75) Inventors: Peter B. GILLINGHAM, Kanata (CA); Hong Beom PYEON, Kanata (CA); Jin-Ki KIM, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: MOSAID TECHNOLOGIES INCORPORATED, Ottawa (CA)

(21) Appl. No.: 12/607,680

(22) Filed: Oct. 28, 2009

Related U.S. Application Data
(63) Continuation-in-part of application No. 12/508,926, filed on Jul. 24, 2009.
(60) Provisional application No. 61/111,013, filed on Nov. 4, 2008.
(60) Provisional application No. 61/184,965, filed on Jun. 8, 2009.

(30) Foreign Application Priority Data
Oct. 14, 2009 (CA) PCT/CA2009/001451

(51) Int. Cl. G06F 13/36; G06F 12/00

(52) U.S. Cl. 710/310; 711/206

(57) ABSTRACT

A composite memory device including discrete memory devices and a bridge device for controlling the discrete memory devices. The bridge device has a virtual page buffer corresponding to each discrete memory device for storing read data from the discrete memory device, or write data from an external device. The virtual page buffer is configurable to have a size up to the maximum physical size of the page buffer of a discrete memory device. The page buffer is then logically divided into page segments, where each page segment corresponds in size to the configured virtual page buffer size. By storing read or write data in the virtual page buffer, both the discrete memory device and the external device can operate to provide or receive data at different data rates to maximize the performance of both devices.

### CROSS REFERENCE TO RELATED APPLICATIONS

This application is a continuation-in-part of U.S. application Ser. No. 12/508,926 filed on Jul. 24, 2009 entitled “A BRIDGING DEVICE HAVING A CONFIGURABLE VIRTUAL PAGE SIZE” and which claims the benefit of: U.S. Provisional Application Ser. No. 61/111,013 titled “SYSTEM HAVING ONE OR MORE NONVOLATILE MEMORY DEVICES,” filed Nov. 4, 2008; and U.S. Provisional Application Ser. No. 61/184,965 titled “A BRIDGING DEVICE HAVING CONFIGURABLE VIRTUAL PAGE SIZE,” filed Jun. 8, 2009, and all of the above-mentioned applications are hereby incorporated by reference.

This application also claims the benefit of: PCT Patent Application Ser. No. PCT/CA2009/001451 titled “A COMPOSITE MEMORY HAVING A BRIDGING DEVICE FOR CONNECTING DISCRETE MEMORY DEVICES TO A SYSTEM,” filed Oct. 14, 2009, which is hereby incorporated by reference.

### BACKGROUND

Semiconductor memory devices are important components in presently available industrial and consumer electronics products. For example, computers, mobile phones, and other portable electronics all rely on some form of memory for storing data. Many memory devices are available as commodity, or discrete memory devices, but also the need for higher levels of integration and higher input/output (I/O) bandwidth has led to the development of embedded memory, which can be integrated with systems, such as microcontrollers and other processing circuits.

Most consumer electronics employ, non-volatile devices, such as flash memory devices, for storage of data. Demand for flash memory devices has continued to grow significantly because these devices are well suited in various applications that require large amounts of non-volatile storage, while occupying a small physical area. For example, flash is widely found in various consumer devices, such as digital cameras, cell phones, universal serial bus (USB) flash drives and portable music players, to store data used by these devices. Also, flash devices are used as solid state drives (SSDs) for hard disk drive (HDD) replacement. Such portable devices are preferably minimized in form factor size and weight. Unfortunately, multimedia and SSD applications require large amounts of memory which can increase the form factor size and weight of their products. Therefore, consumer product manufacturers compromise by limiting the amount of physical memory included in the product to keep its size and weight acceptable to consumers. Furthermore, while flash memory may have a higher density per unit area than DRAM or SRAM, its performance is typically limited due to its relatively low I/O bandwidth that negatively impacts its read and write throughput.

In order to meet the ever-increasing demand and ubiquitous nature of memory device applications, it is desirable to have high-performance memory devices, i.e., devices having higher I/O bandwidth, higher read and write throughput, and increased flexibility of operations.

### SUMMARY

In a first aspect, there is provided a bridge device. The bridge device includes a virtual page buffer, a bridge device interface and a memory device interface. The virtual page buffer stores data. The bridge device interface transfers data between an external device and the virtual page buffer at a first data rate in response to a global command. The memory device interface transfers data between a memory device and the virtual page buffer at a second data rate in response to a local command. According to a present embodiment, the memory device includes a page buffer having a fixed maximum size and the virtual page buffer is configurable to have a size equal to the fixed maximum size of the page buffer. The virtual page buffer can be configured to have a size corresponding to a page segment of the page buffer, such that the memory device interface transfers the data corresponding to the page segment between the memory device and the virtual page buffer.

In the present embodiment, the global command includes a virtual page address for selecting the page segment of the page buffer, wherein the page segment is one of 2ⁿ page segments and the virtual page address is an n-bit address, where n is an integer number of at least 1. The global command can further include a virtual column address for selecting a bit of the page segment. The bridge device can further include a converter circuit for converting the virtual page address into a physical address corresponding to the page segment, wherein the converter circuit generates the local command to include the physical address in a format compatible with the memory device.

In an alternate embodiment of the present aspect, the memory device is a first memory device, the virtual page buffer is a first virtual page buffer, and the memory interface is coupled to a second memory device for transferring data between the second memory device and a second virtual page buffer. In this alternate embodiment, the bridge device further includes a virtual page size configuration circuit for configuring the size of the first virtual page buffer and the second virtual page buffer in response to a virtual page size configuration command. The virtual page size configuration command includes an op-code field followed by a first virtual page size data field containing a first configuration code corresponding to the first virtual page buffer, and a second virtual page size data field containing a second configuration code corresponding to the second virtual page buffer.

In yet other embodiments of the present aspect, the first data rate is greater than the second data rate, and the bridge device further includes data path circuits for transferring data between the bridge device interface and the virtual page buffer at the first data rate. The data path circuits can include a data input path circuit for transferring write data received at the bridge device interface to the virtual page buffer for storage in the virtual page buffer, and a data output path circuit for transferring read data stored in the virtual page buffer to the bridge device interface. The virtual page buffer includes a memory, which has a first input port, a first output port, a second input port and a second output port. The first input port receives the write data from the data input path circuit. The first output port provides the read data to the data output path circuit. The second input port receives the read from the memory device interface. The second output port provides the write data stored in the memory. The bridge device can further include a converter circuit for receiving the write data from the second output port of the memory and for generating the local command to transfer the write data to the memory device. In a further embodiment of the present aspect, the memory device interface is asynchronous and the bridge device interface is a synchronous interface receiving a clock signal. In another embodiment, the memory device interface provides the local command in a parallel format, and the bridge device interface receives the global command in a serial format.

In a second aspect, there is provided a bridge device having a memory device interface, a virtual page buffer and a bridge device interface. The memory device interface receives read data at a first data rate. The virtual page buffer stores the read data received by the memory device interface. The bridge device interface outputs the read data stored in the memory device interface at a second data rate.

In a third aspect, there is provided a bridge device having a bridge device input/output interface, a virtual page buffer and a memory device interface. The bridge device input/output interface receives write data at first data rate. The virtual page buffer stores the write data received by the bridge device interface. The memory device interface outputs the write data stored in the virtual page buffer at a second data rate.

In a fourth aspect, there is provided a method for accessing read data from a discrete memory device with a bridge device. The method includes providing a read address corresponding to the read data to the discrete memory device; receiving the read data from the discrete memory device; storing the read data in a virtual page buffer of the bridge device; and outputting the read data stored in the virtual page buffer. According to a present embodiment, providing includes receiving a global page read command having the read address, and receiving the global page read command includes issuing a local page read command when the read address corresponds to a new physical page. Alternately, receiving the global page read command includes issuing a local burst data read command to the discrete memory device when the read address corresponds to a previously accessed physical page. In the present embodiment, issuing includes execution of a core read operation by the discrete memory device in response to the local page read command to access the read data from the new physical page, and receiving the read data includes issuing a local burst data read command to the discrete memory device after a core read time for reading the new physical page of the discrete memory device has elapsed.

In another embodiment of the present aspect, the read address includes a virtual page address corresponding to a page segment of a physical page of the discrete memory device, where the page segment is one of 2ⁿ page segments and the virtual page address is an n-bit address for selecting the page segment, where n is an integer number of at least 1. The read address can include a virtual column address for selecting a bit of the page segment, and providing the read address includes converting the virtual page address and the virtual column address into a physical address corresponding to the page segment.

In a fifth aspect, there is provided a method for writing data to a discrete memory device with a bridge device. The method includes receiving a global page program command; storing write data to a virtual page buffer of the bridge device; transferring the write data stored in the virtual page buffer to a discrete memory device; and, issuing a local program command to the discrete memory device.

### BRIEF DESCRIPTION OF THE DRAWINGS

Reference will now be made, by way of example, to the accompanying drawings:

FIG. 1A is a block diagram of an example non-volatile memory system;

FIG. 1B is a diagram of a discrete flash memory device used in the example memory system of FIG. 1A;

FIG. 2A is a block diagram of an example serial memory system;

FIG. 2B is a diagram of a discrete serial interface flash memory device used in the example memory system of FIG. 2A;

FIG. 3A is a block diagram of a composite memory device having four discrete memory devices and a bridge device in accordance with an embodiment;

FIG. 3B is an illustration of a global command, according to a present embodiment;

FIG. 4 is a block diagram of a bridge device in accordance with an embodiment;

FIG. 5 is a block diagram of a memory system having a number of composite memory devices connected to a controller in a serial interconnected memory system in accordance with an embodiment;

FIG. 6 is a block diagram showing memory mapping of the bridge device to NAND flash memory devices, according to a present embodiment;

FIG. 7A is a flow chart illustrating a method of reading data from a discrete memory device using a bridge device, according to a present embodiment;

FIGS. 7B, 7C, 7D and 7E illustrate an example read operation from one NAND flash memory device using a bridge device;

FIG. 8 is a flow chart illustrating a method of programming data in a discrete memory device using a bridge device, according to a present embodiment;

FIGS. 9A, 9B, 9C and 9D illustrate example virtual page configurations for each memory bank of a bridge device;

FIG. 10 is a table showing example commands for the bridge device, according to a present embodiment;

FIG. 11 is an example mapping of op-code and addressing bits for the commands shown in FIG. 10;

FIG. 12 is a table showing example VPS configuration codes, according to a present embodiment;

FIG. 13 is a block diagram of a NAND to a high speed serial interface bridge device, according to a present embodiment; and,

FIG. 14 is an illustration of a VPS configuration command, according to a present embodiment.

### DETAILED DESCRIPTION

Generally, at least some embodiments are directed to a bridge device for transferring data between at least one other device and a memory device. More specifically, the bridge device includes a virtual page buffer for storing data, a bridge device input/output interface for transferring data between the at least one other device and the virtual page buffer at a first data rate, and a memory device interface for transferring data between the memory device and the virtual page buffer at a second data rate. In embodiments where the first data rate and the second data rate are different from each other, use of the virtual page buffer allows both the memory device and the at least one other device to operate at their respective data rates.

Other embodiments are directed to a composite memory device including memory devices such as discrete memory devices, and a bridge device for controlling the discrete memory devices in response to global memory control signals having a format or protocol that is incompatible with the memory devices. The discrete memory devices can be commercial off-the-shelf memory devices or custom memory devices, which respond to native, or local memory control signals. The global and local memory control signals include commands and command signals each having different formats. The global memory control signals are received from or provided to at least one other device, which can include another bridge device or a host device such as a memory controller.

To improve overall read and write performance of the composite memory device relative to the discrete memory devices, the bridge device is configured to receive write data and to provide read data at a frequency greater than the maximum rated frequency of the discrete memory devices. For the purposes of describing the present embodiments, a write operation and a program operation are treated as analogous functions, since in both cases data is stored in the cells of the memory. However, the discrete memory devices within the composite memory device operate cannot provide its read data fast enough to the bridge device in real time so that the bridge device can output the read data at its higher data rate. Therefore to compensate for this mismatch in speed, the bridge device includes virtual page buffers to temporarily store at least a portion of a page of data read from the page buffer of a discrete memory device, or to be written to the page buffer of a discrete memory device.

The system and device in accordance with the techniques described herein are applicable to a memory system having a plurality of devices connected in series. The devices are, for example, memory devices, such as dynamic random access memories (DRAMs), static random access memories (SRAMs), NAND flash memories, NOR Flash memories, Serial EEPROM memories, Ferro RAM memories, Magneto RAM memories, Phase Change RAM memories, and any other suitable type of memory.

Following are descriptions of two different memory devices and systems to facilitate a better understanding of the later described composite memory device and bridge device embodiments.

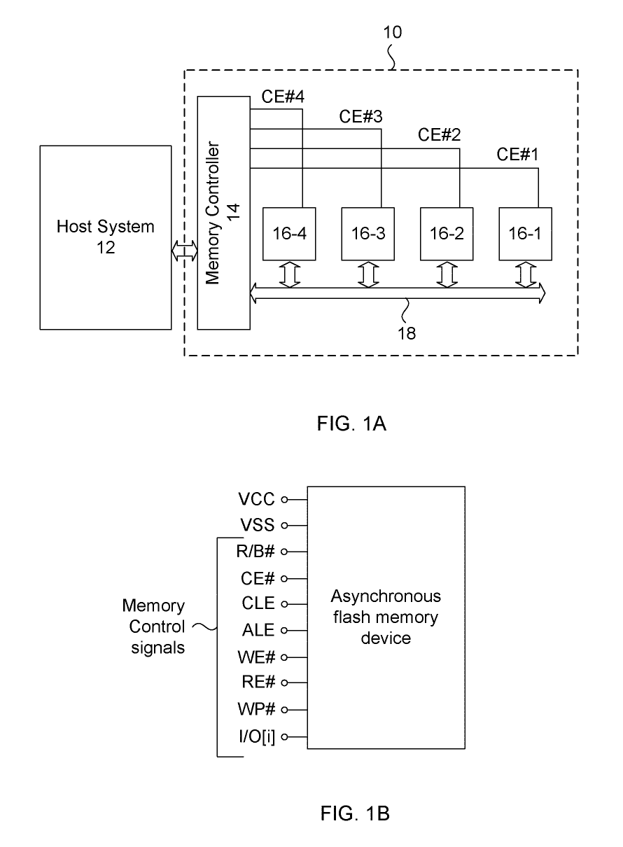

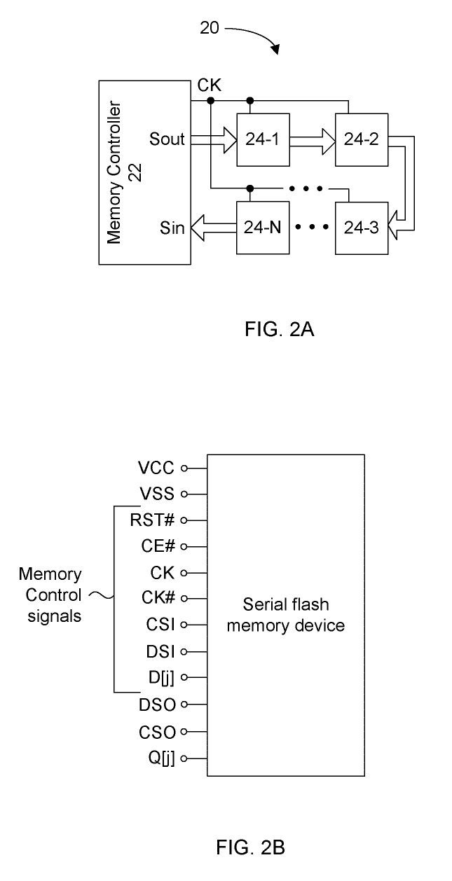

FIG. 1A is a block diagram of a non-volatile memory system 10 integrated with a host system 12. The system 10 includes a memory controller 14 in communication with host system 12, and a plurality of non-volatile memory devices 16-1, 16-2, 16-3 and 16-4. For example the non-volatile memory devices 16-1-16-4 can be discrete asynchronous flash memory devices. The host system 12 includes a processing device such as a microcontroller, microprocessor, or a computer system. The system 10 of FIG. 1A is organized to include one channel 18, with the memory devices 16-1-16-4 being connected in parallel to channel 18. Those skilled in the art should understand that the system 10 can have more or fewer than four memory devices connected to it. In the presently shown example, the memory devices 16-1-16-4 are asynchronous and connected in parallel with each other.

Channel 18 includes a set of common buses, which include data and control lines that are connected to all of its corresponding memory devices. Each memory device is enabled or disabled with respective chip select (enable) signals CE1#, CE2#, CE3# and CE4#, provided by memory controller 14. In this and following examples, the “#” indicates that the signal is an active low logic level signal (ie. logic “0” state). In this scheme, one of the chip select signals is typically selected at one time to enable a corresponding one of the non-volatile memory devices 16-1-16-4. The memory controller 14 is responsible for issuing commands and data, via the channel 18, to a selected memory device in response to the operation of the host system 12. Read data output from the memory devices is transferred via the channel 18 back to the memory controller 14 and host system 12. The system 10 is generally said to include a multi-drop bus, in which the memory devices 16-1-16-4 are connected in parallel with respect to channel 18.

FIG. 1B is a diagram of one of the discrete flash memory devices 16-1-16-4 which can be used in the memory system of FIG. 1A. This flash memory device includes several input and output ports, which include for example power supply, control ports and data ports. The term “ports” refers to a generic input or output terminals into the memory device, which includes package pins, package solder bumps, and chip bond pads for example. The power supply ports include VCC and VSS for supplying power to all the circuits of the flash memory device. Additional power supply ports can be provided for supplying only the input and output buffers, as is well known in the art. Table 1 below provides an example listing of the control and data ports, their corresponding descriptions, definitions, and example logic states. It should be noted that different memory devices may have differently named control and data ports which may be functionally equivalent to those shown in Table 1, but follow protocols specific to that type of memory device. Such protocols may be governed by an established standard, or customized for a particular application. It is noted that that package pins and ball grid arrays are physical examples of a port, which is used for interconnecting signals or voltages of a packaged device to a board. The ports can include other types of connections, such as for example, terminals and contacts for embedded and system-in-package (SIP) systems.

TABLE 1

| Port | Description |
|---|---|
| R/B# | Ready/Busy: the R/B# is open drain port and the output signal is used to indicate |
| | the operating condition of the device. The R/B# signal is in Busy state (R/B# = |
| | LOW) during the Program, Erase and Read operations and will return to Ready |
| | state (R/B# = HIGH) after completion of the operation. |
| CE# | Chip Enable: the device goes into a low-power Standby mode when CE# goes |
| | HIGH during the device is in Ready state. The CE# signal is ignored when device |
| | is in Busy state (R/B# = LOW), such as during a Program or Erase or Read |
| | operation, and will not enter Standby mode even if the CE# input goes HIGH |
| CLE | Command Latch Enable: the CLE input signal is used to control loading of the |
| | operation mode command into the internal command register. The command is |
| | latched into the command register from the I/O port on the rising edge of the WE# |
| | signal while CLE is HIGH. |
| ALE | Address Latch Enable (ALE): the ALE signal is used to control loading address |
| | information into the internal address register. Address information is latched into |
| | the address register from the I/O port on the rising edge of the WE# signal while |
| | ALE is HIGH. |
| WE# | Write Enable: the WE# signal is used to control the acquisition of data from the I/O |
| | port. |
| RE# | Read Enable: the RE signal controls serial data output. Data is available after the |
| | falling edge of RE#. |
| WP# | Write Protect: the WP# signal is used to protect the device from accidental |
| | programming or erasing. The internal voltage regulator (high voltage generator) is |
| | reset when WP# is LOW. This signal is usually used for protecting the data during |
| | the power-on/off sequence when input signals are invalid. |
| I/O[i] | I/O Port: are used as a port for transferring address, command and input/output |
| | data to and from the device. Variable n can be any non-zero integer value. |

All the signals noted in Table 1 are generally referred to as the memory control signals for operation of the example flash memory device illustrated in FIG. 1B. It is noted that the last port I/O[i] is considered a memory control signal as it can receive commands which instruct the flash memory device to execute specific operations. Because a command asserted on port I/O[i] is a combination of logic states applied to each individual signal line making up I/O[i], the logic state of each signal of I/O[i] functions in the same manner as one of the other memory control signals, such as WP# for example. A specific combination of I/O[i] logic states controls the flash memory device to perform a function. The commands are received via its I/O ports and the command signals include the remaining control ports. Those skilled in the art understand that operational codes (op-codes) are provided in the command for executing specific memory operations. With the exception of the chip enable CE# and optionally R/B#, all the other ports are coupled to respective global lines that make up channel 18. All the ports are controlled in a predetermined manner for executing memory operations. This includes signal timing and sequencing of specific control signals while address, command and I/O data is provided on the I/O ports. Therefore, the memory control signals for controlling the asynchronous flash memory device of FIG. 1B has a specific format, or protocol.

Each of the non-volatile memory devices of FIG. 1A has one specific data interface for receiving and providing data. In the example of FIG. 1A, this is a parallel data interface commonly used in asynchronous flash memory devices, as well as in some synchronous flash memory devices such as those specified in the ONFi 2.0 standard. Standard parallel data interfaces providing multiple bits of data in parallel are known to suffer from well known communication degrading effects such as loading which degrades signal quality and progressively limits the rated operating frequency as more devices are connected to the shared bus.

In order to increase data throughput, a memory device having a serial data interface has been disclosed in commonly owned U.S. Patent Publication No. 20070153576 entitled “Memory with Output Control”, and commonly owned U.S. Patent Publication No. 20070076502 entitled “Daisy Chain Cascading Devices” which receives and provides data serially and synchronously at a frequency of, for example, 200 MHz. This is referred to as a serial data interface format. As shown in these commonly owned patent publications, the described memory device can be used in a system of memory devices that are serially connected to each other.

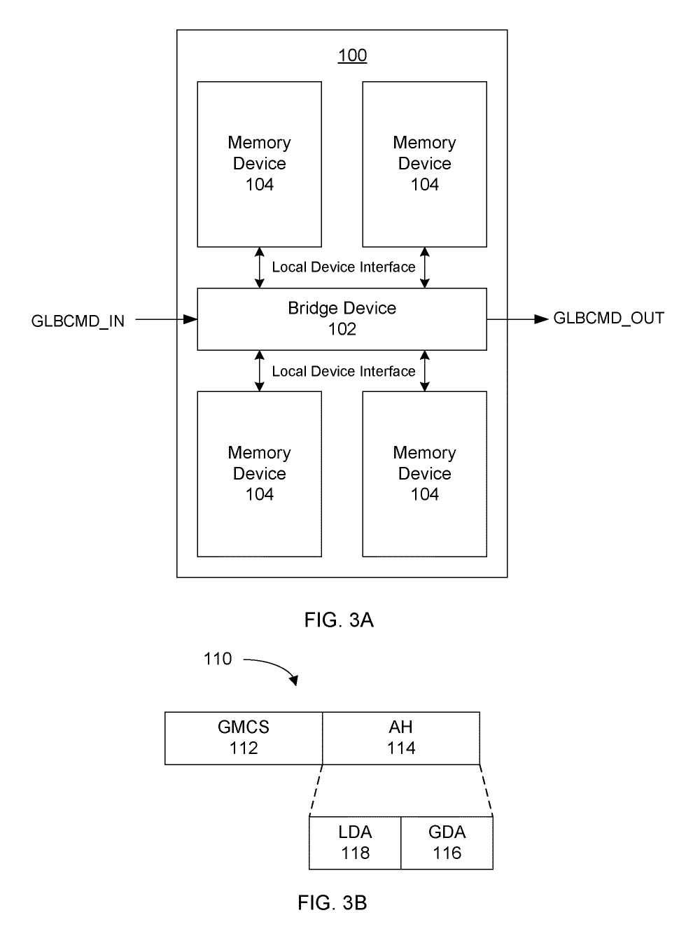

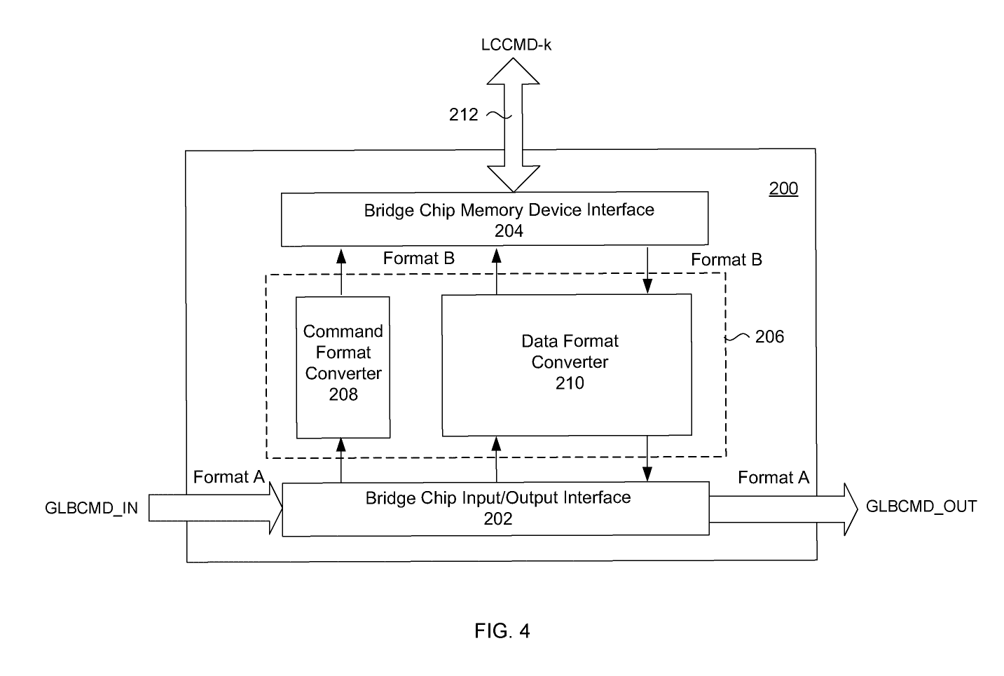

FIG. 2A is a block diagram illustrating the conceptual nature of a serial memory system. In FIG. 2A, the serial ring-topology memory system 20 includes a memory controller 22 having a set of output ports Sout and a set of input ports Sin, and memory devices 24-1, 24-2, 24-3 and 24-N that are connected in series. The memory devices can be serial interface flash memory devices for example. While not labeled in FIG. 2A, each memory device has a set of input ports Sin and a set of output ports Sout. These sets of input and output ports includes one or more individual input/output (I/O) ports, such as physical pins or connections, interfacing the memory device to the system it is a part of. In one example, the memory devices can be NAND flash memory devices. Alternately, the memory devices can be DRAM, SRAM, NOR Flash, Serial EEPROM, Ferro RAM, Magneto RAM, Phase Change RAM, or any other suitable type of memory device that has an I/O interface compatible with a specific command structure, for executing commands or for passing commands and data through to the next memory device. The current example of FIG. 2A includes four memory devices, but alternate configurations can include a single memory device, or any suitable number of memory devices. Accordingly, if memory device 24-1 is the first device of the system 20 as it is connected to Sout, then memory device 24-N is the Nth or last device as it is connected to Sin, where N is an integer number greater than zero. Memory devices 24-2, 24-3 and any memory devices between 24-3 and 24-N are then intervening serially connected memory devices between the first and last memory devices. In the example of FIG. 2A, the memory devices 24-1 to 24-N are synchronous and connected in series with each other and the memory controller 22.

FIG. 2B is a diagram of the serial interface flash memory device (24-1 to 24-N for example) which can be used in the memory system of FIG. 2A. This example serial interface flash memory device includes power supply ports, control ports and data ports. The power supply ports include VCC and VSS for supplying power to all the circuits of the flash memory device. Additional power supply ports can be provided for supplying only the input and output buffers, as is well known in the art. Table 2 below provides an example listing of the control and data ports, their corresponding descriptions, definitions, and example logic states. It should be noted that different memory devices may have differently named control and data ports which may be functionally equivalent to those shown in Table 1, but follow protocols specific to that type of memory device. Such protocols may be governed by an established standard, or customized for a particular application.

TABLE 2

| Port | Description |
|---|---|
| CK/ | Clock: CK is the system clock input. CK and CK# are differential clock inputs. All |
| CK# | commands, addresses, input data and output data are referenced to the crossing |
| | edges of CK and CK# in both directions. |
| CE# | Chip Enable: When CE# is LOW, the device is enabled. Once the device starts a |
| | Program or Erase operation, the Chip Enable port can be de-asserted. In addition, |
| | CE# LOW activates and CE# HIGH deactivates the internal clock signals. |
| RST# | Chip Reset: RST# provides a reset for the device. When RST# is HIGH, the device |
| | is on the normal operating mode. When RST# is LOW, the device will enter the |
| | Reset mode. |
| D[j] | Data Input: (j = 1, 2, 3, 4, 5, 6, 7 or 8) receives command, address and input data. If the |
| | device is configured in ‘1-bit Link mode (=default)’, D1 is the only valid signal and |
| | receives one byte of packet in 8 crossings of CK/CK#. If the device is configured in |
| | ‘2-bit Link mode’, D1 & D2 are only valid signals and receive one byte of packet in |
| | 4 crossings of CK/CK#. If the device is configured in ‘4-bit Link mode’, D1, D2, D3 |
| | & D4 are only valid signals and receive one byte of packet in 2 crossings of |
| | CK/CK#. Unused input ports are grounded. If the device is configured in ‘8-bit Link |
| | mode’, all D[j] are valid signals and receive one byte of packet in a single crossing |
| | of CK/CK#. |
| Q[j] | Data Output: (j = 1, 2, 3, 4, 5, 6, 7 or 8) transmits output data during read operation. If |
| | device is configured in ‘1-bit Link mode (=default)’, Q1 is the only valid signal and |
| | transmits one byte of packet in 8 crossings of CK/CK#. If the device is configured |
| | in ‘2-bit Link mode’, Q1 & Q2 are the only valid signals and transmit one byte of |
| | packet in 4 crossings of CK/CK#. If the device is configured in ‘4-bit Link mode’, |
| | Q1, Q2, Q3 & Q4 are the only valid signals and transmit one byte of packet in 2 |
| | crossings of CK/CK#. Unused output ports are DNC (=Do Not Connect). If the |
| | device is configured in ‘8-bit Link mode’, all Q[j] are valid signals and transmit one |
| | byte of packet in a single crossing of CK/CK#. |
| CSI | Command Strobe Input: When CSI is HIGH, command, address and input data |
| | through D[j] are latched on the crossing of CK and CK#. When CSI is LOW, the |
| | device ignores input signals from D[j]. |
| CSO | Command Strobe Output: The echo signal CSO is a re-transmitted version of the |
| | input signal CSI. |
| DSI | Data Strobe Input: Enables data output at the Q[j] buffer when HIGH. When DSI is |
| | LOW, the Q[j] buffer outputs a re-transmitted version of the D[j] input. |
| DSO | Data Strobe Output: The echo signal DSO is a re-transmitted version of the input |
| | signal DSI. |

With the exception of signals CSO, DSO and Q[j], all the signals noted in Table 2 are the memory control signals for operation of the example flash memory device illustrated in FIG. 2B. CSO and DSO are retransmitted versions of CSI and DSI, and Q[j] is an output for providing commands and data. The commands are received via its D[j] ports and the command signals include the control ports RST#, CE#, CK, CK#, CSI and DSI. In the example configuration shown in FIG. 2A, all signals are passed serially from the memory controller 22 to each memory device in series, with the exception of CK, CK#, CE# and RST#, which are provided to all the memory devices in parallel. The serial interface flash memory device of FIG. 2B thus receives memory control signals having its own format or protocol, for executing memory operations therein.

Further details of the serially connected memory system of FIG. 2 are disclosed in commonly owned U.S. Patent Publication No. 20090039927 entitled “Clock Mode Determination in a Memory System” filed on Feb. 15, 2008, which describes a serial memory system in which each memory device receives a parallel clock signal, and a serial memory system in which each memory device receives a source synchronous clock signal.

Having both the commonly available asynchronous flash memory devices of FIG. 1B and the serial interface flash memory devices of FIG. 2B allows a memory system manufacturer to provide both types of memory systems. However, this will likely introduce higher cost to the memory system manufacturer since two different types of memory devices must be sourced and purchased. Those skilled in the art understand that the price per memory device decreases when large quantities are purchased, hence large quantities are purchased to minimize the cost of the memory system. Therefore, while a manufacturer can provide both types of memory systems, it bears the risk of having one type of memory device fall out of market demand due the high market demand of the other. This may leave them with purchased supplies of a memory device that cannot be used.

As shown in FIG. 1B and FIG. 2B, the functional port assignments or definitions of the asynchronous and serial interface flash memory devices are substantially different from each other, and are accordingly, incompatible with each other. The functional port definitions and sequence, or timing, of sets of signals used for controlling the discrete memory devices is referred to as a protocol or format. Therefore the asynchronous and serial flash memory devices operate in response to different memory control signal formats. This means that the serial interface flash memory device of FIG. 2B cannot be used in a multi-drop memory system, and correspondingly, the asynchronous flash memory device of FIG. 1B cannot be used in a serial connected ring topology memory system.

Although serial interface flash memory devices as shown in FIG. 2A and FIG. 2B are desirable for their improved performance over the asynchronous flash memory devices of FIGS. 1A and 1B, memory system manufacturers may not wish to dispose of their supplies of asynchronous flash memory devices. Furthermore, due to their ubiquitous use in the industry, asynchronous flash memory devices are inexpensive to purchase relative to alternative flash memory devices such as the serial interface flash memory device of FIG. 2A. Presently, memory system manufacturers do not have a solution for taking advantage of the performance benefits of serially interconnected devices with minimal cost overhead.

At least some example embodiments described herein provide a high performance composite memory device with a high-speed interface chip or a bridge device in conjunction with discrete memory devices, in a multi-chip package (MCP) or system in package (SIP). The bridge device provides an I/O interface with the system it is integrated within, and receives global memory control signals following a global format, and converts the commands into local memory control signals following a native or local format compatible with the discrete memory devices. A global or local format includes signals that follow a particular signaling protocol, sequence and/or timing relative to each other. The bridge device thereby allows for re-use of discrete memory devices, such as NAND flash devices, while providing the performance benefits afforded by the I/O interface of the bridge device. The bridge device can be formed as a discrete logic die integrated with the discrete memory device dies in the package. Alternately, the bridge device can be formed as a discrete packaged device bonded to a printed circuit board and electrically connected to packaged discrete memory devices.

In the present examples, the global format is a serial data format compatible with the serial flash memory device of FIGS. 2A and 2B, and the local format is a parallel data format compatible with the asynchronous flash memory device of FIGS. 1A and 2B. However, the embodiments of the present invention are not limited to the above example formats, as any pair of memory control signal formats can be used, depending the type of discrete memory devices used in the composite memory device and the type of memory system the composite memory device is used within. For example, the global format of the memory system can follow the Open NAND Flash Interface (ONFi) standard, and the local format can follow the asynchronous flash memory device memory control signal format. For example, a specific ONFi standard is the ONFi 2.0 Specification. Alternatively, both the global format and the local format can follow the same standard, such as the ONFi 2.0 Specification format or asynchronous flash memory device memory control signal format. This provides the benefit of reduced loading and the capability to support more memory per channel. In general, the ONFi specification is a multi-drop synchronous protocol where data and commands are provided to the compliant memory device via its data input/output ports synchronously with a clock. In otherwords, an ONFi compliant memory device can have some similarities to an asynchronous NAND flash memory device having parallel bi-directional input/output ports with one important difference being that the ONFi compliant device receives a clock signal.

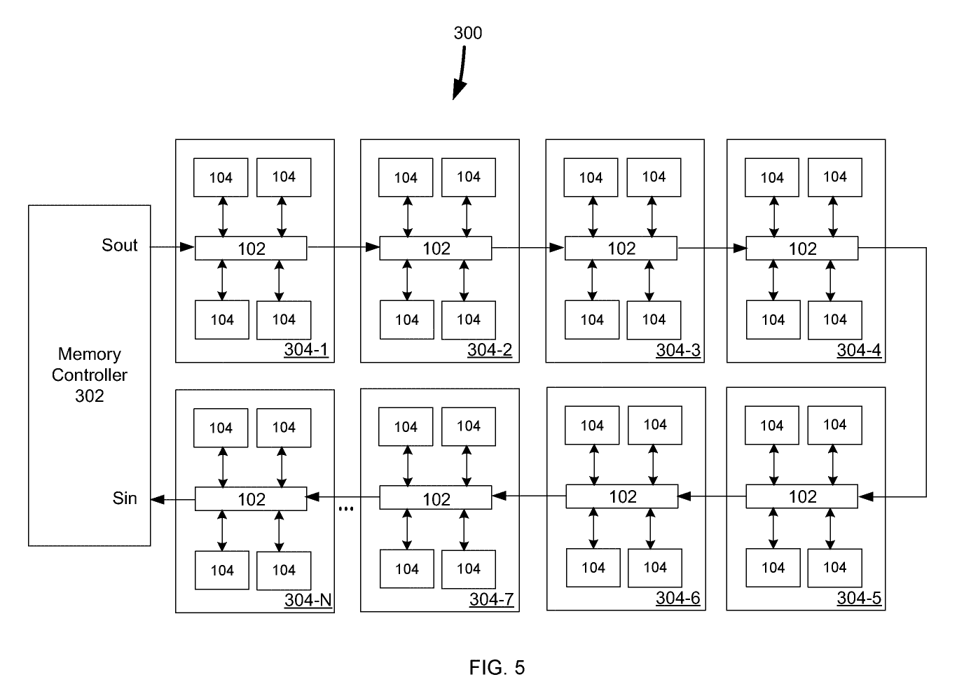

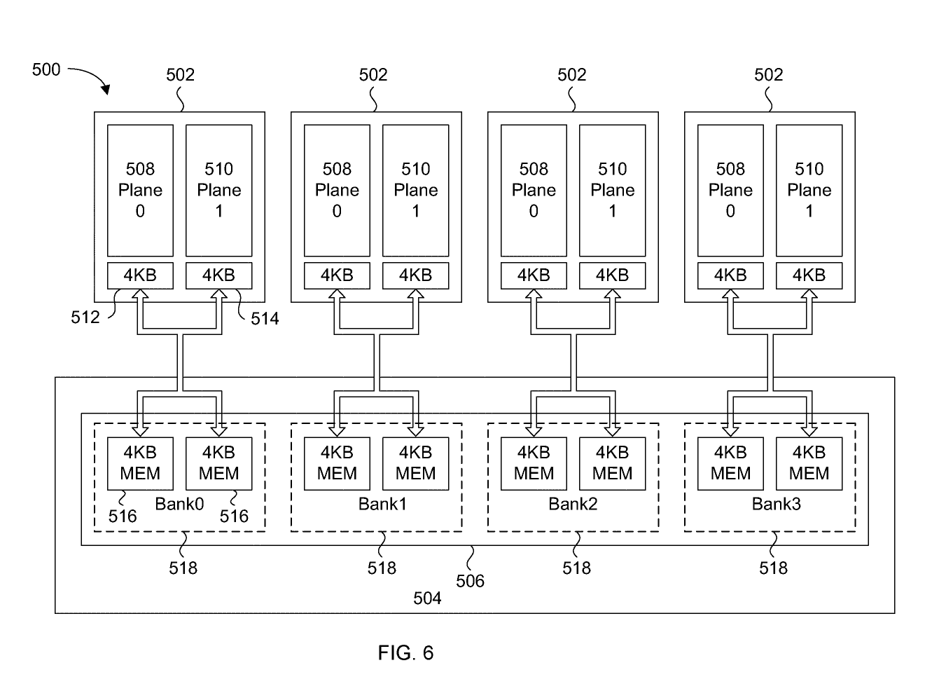

FIG. 3A is a block diagram of a composite memory device, according to a present embodiment. As shown in FIG. 3A, composite memory device 100 includes a bridge device 102 connected to four discrete memory devices 104. Each of the discrete memory devices 104 can be asynchronous flash memory devices having a memory capacity of 8 Gb, for example, but any interface or capacity discrete flash memory device can be used instead of 8 Gb devices. Furthermore, composite memory device 100 is not limited to having four discrete memory devices. Any number of discrete memory devices can be included, when bridge device 102 is designed to accommodate the maximum number of discrete memory devices in the composite memory device 100. For example, 8 discrete memory devices 104 could be supported using the bridge device 102 shown by connecting 2 discrete memory devices 104 to each of the 4 local device interfaces. Alternatively, a bridge device 102 with 8 local device interfaces could be used with a single discrete memory device 104 connected to each local device interface.

Composite memory device 100 has an input port GLBCMD_IN for receiving global command and write data, and an output port GLBCMD_OUT for passing the received global command and read data. FIG. 3B is a schematic illustrating the hierarchy of a global command, according to a present embodiment. The global command 110 includes global memory control signals (GMCS) 112 having a specific format, and an address header (AH) 114. These global memory control signals 112 provide a memory command and command signals, such as the memory control signals for the serial interface flash memory device of FIG. 2B. The address header 114 includes addressing information used at the system level and the composite memory device level. This additional addressing information includes a global device address (GDA) 116 for selecting a composite memory device to execute an op-code in the memory command, and a local device address (LDA) 118 for selecting a particular discrete device within the selected composite memory device to execute the op-code. In summary, the global command uses all the memory control signals corresponding to one format, and further addressing information which may be required for selecting or controlling the composite memory device or the discrete memory devices therein.

It is noted that bridge device 102 does not execute the op-code or access any memory location with the row and address information. The bridge device 102 uses the global device address 116 to determine if it is selected to convert the received global memory control signals 112. If selected, bridge device 102 then uses the local device address 118 to determine which of the discrete memory devices the converted global memory control signals 112 is sent to. In order to communicate with all four discrete memory devices 104, bridge device 102 includes four sets of local device interfaces, each connected to a corresponding discrete memory device, as will be discussed later. Each set of local device interfaces includes all the signals that the discrete memory device requires for proper operation, and thereby functions as a local device interface.

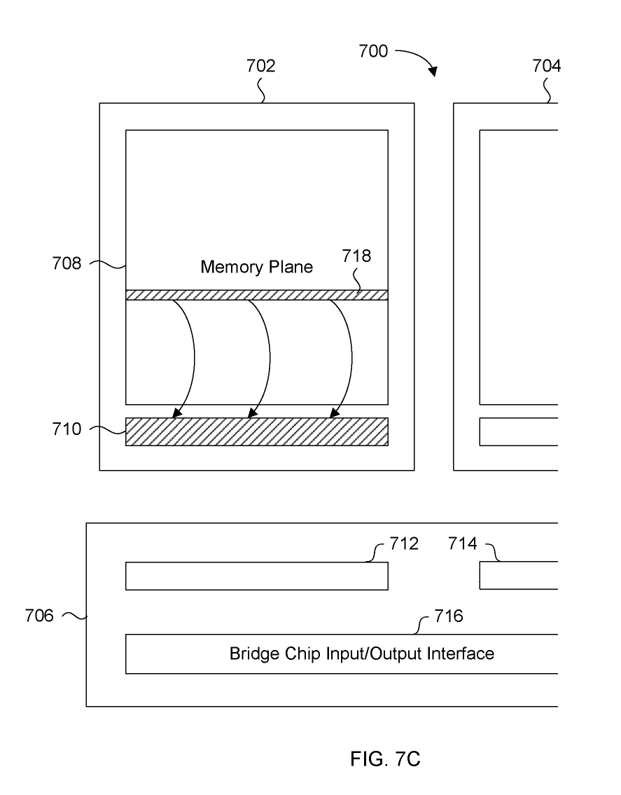

Read data is provided by any one of a discrete memory device 104 from composite memory device 100, or from a previous composite memory device. In particular, the bridge device 102 can be connected to a memory controller of a memory system, or to another bridge device of another composite memory device in a system of serially interconnected devices. The input port GLBCMD_IN and output port GLBCMD_OUT can be package pins, other physical conductors, or any other circuits for transmitting/receiving the global command signals and read data to and from the composite memory device 100, and in particular, to and from bridge device 102. The bridge device 102 therefore has corresponding connections to the input port GLBCMD_IN and the output port GLBCMD_OUT to enable communication with an external device, such as memory controller 22 of FIG. 2A, or with the bridge devices from other composite memory devices in the system. As will be shown in the example embodiment of FIG. 6, many composite memory devices can be connected serially to each other.

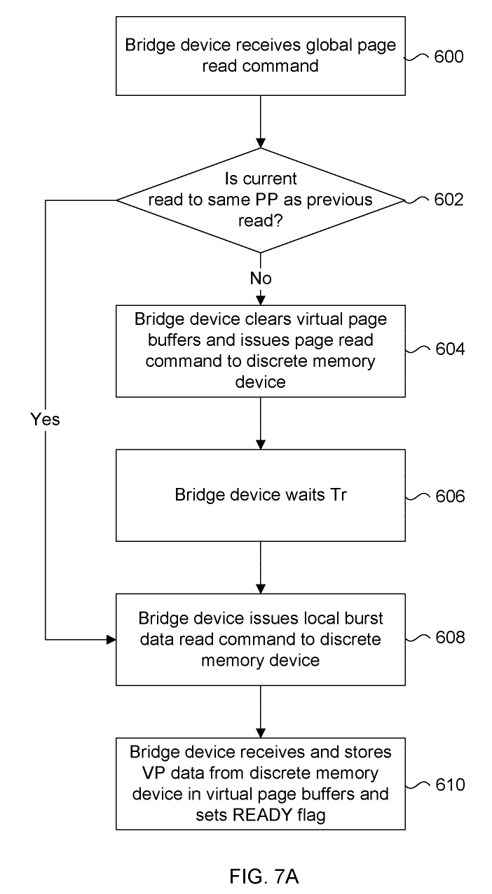

FIG. 4 is a block diagram of a bridge device 200 in accordance with an embodiment, which corresponds to the bridge device 102 shown in FIG. 3A. The bridge device 200 has a bridge device input/output interface 202, a memory device interface 204, and a format converter 206. The format converter 206 includes a command format converter 208 for converting global memory control signals, which include global commands and global command signals in a first format to a second format, and a data format converter 210 for converting data between the first format and the second format. For example, the first format may be a parallel data format while the second format is a serial data format, or vice versa. As will be discussed later, the data format converter 210 includes a memory, referred to as a virtual page buffer, that is used for storing read and write data. The command format converter 208 further includes a state machine (not shown) for controlling the discrete memory devices, such as discrete memory devices 104 of FIG. 3A in accordance with the second format in response to the global memory control signals in the first format.

The bridge device input/output interface 202 communicates with external devices, such as for example, with a memory controller or another composite memory device. The bridge device input/output interface 202 receives global commands from a memory controller or another composite memory device in the global format, such as for example in a serial command format. With further reference to FIG. 3B, logic in the input/output interface 202 processes the global device address 116 of the global command 110 to determine if the global command 110 is addressed to the corresponding composite memory device, and processes the local device address 118 in the global command 110 to determine which of the discrete memory devices of the corresponding composite memory device is to receive the converted command, which includes an op-code and optional row and column addresses and optional write data. If the global command is addressed to a discrete memory device connected to bridge device 200, the command format converter 208 in the format converter 206 converts the global memory control signals 112, which provides the op-code and command signals and any row and address information from the global format to the local format, and forwards it to the memory device interface 204. If write data is provided to bridge device input/output interface 202 in a serial data format for example, then bridge device input/output interface 202 includes serial-to-parallel conversion circuitry for providing bits of data in a parallel format. For read operations, bridge device input/output interface 202 includes parallel-to-serial conversion circuitry for providing bits of data in serial format for output through the GLBCMD_OUT output port.

It is assumed that the global format and the local format are known, hence logic in command format converter 208 is specifically designed to execute the logical conversion of the signals to be compatible with the discrete memory devices 104. It is noted that command format converter 208 can include control logic at least substantially similar to that of a memory controller of a memory system, which is used for controlling the discrete memory devices with memory control signals having a native format. For example, command format converter 208 may include the same control logic of memory controller 14 of FIG. 1A if the discrete memory devices are asynchronous memory devices, such as memory devices 16-1 to 16-4. This means that the control logic in command format converter 208 provides the timing and sequencing of the memory control signals in the local format compatible with the discrete memory devices.

If the global command corresponds to a data write operation, the data format converter 210 in the format converter 206 converts the data from the global format to the local format, and forwards it to the memory device interface 204. The bits of read or write data do not require logical conversion, hence data format converter 210 ensures proper mapping of the bit positions of the data between the first data format and the second data format. For example, if the local format uses an 8-bit wide data I/O, then the data format converter 210 provides 8 bits of data at a time to memory device interface 204. The global data format can be serial, such the data is provided in one or more bitstreams. Alternately, the global data format can be another parallel data format, having the same data I/O width or a larger data I/O width. Format converter 206 functions as a data buffer for storing read data from the discrete memory devices or write data received from the bridge device input/output interface 202. Therefore, data width mismatches between the global format and the local format can be accommodated. Furthermore, different data transmission rates between the discrete memory devices and the bridge device 200, and the bridge device 200 and other composite memory devices are accommodated due to the buffering functionality of data format converter 210.

The memory device interface 204 then forwards or communicates the converted command in the local command format to the discrete memory device selected by the local device address 118 in the global command 110 of FIG. 3B. In the present embodiment, the converted command is provided via a command path 212. In an embodiment, command path 212 includes i sets of dedicated local I/O ports LCCMD-k, or channels, connected between each discrete memory device in the composite memory device and the memory device interface 204. The variable i is an integer number corresponding to the number of discrete memory devices in the composite memory device. For example, each LCCMD-k channel includes all the ports shown in FIG. 1B and Table 1.

Following is a description of example operations of bridge device 200, with further reference to the composite memory device 100 of FIG. 3A. For a read operation, a global command is received, such as a global read command arriving at the bridge device input/output interface 202 through input port GLBCMD_IN. This global read command includes the global memory control signals that provide an op-code and row and column information in the global format, for data to be read out from a discrete memory device 104 connected to the bridge device 200. Once the bridge device input/output interface 202 determines that it has been selected for the global read command by comparing the global device address 116 to a predetermined address of the composite memory device 100, the command format converter 208 converts the global read command into the local format compatible with the discrete memory device 104 on which the read data command is to be executed. As will be described later, the composite memory device can have an assigned address. The local device address 118 of the global read command is forwarded to the memory device interface 204, and the converted read data command is provided to the discrete memory device addressed by the local device address via a corresponding set of local I/O ports of the command path 212. Subsequently the selected discrete memory device 104 performs an internal read operation and provides read data on the local I/O ports when requested by the bridge device 200. The read data is temporarily stored within the bridge device 200 for eventual access over the global input/output interface 202. The above-described actions of the command format converter 208 are a simplified description of how data can be read from a discrete memory device 104. It should be noted that command format converter 208 can include a state machine for issuing multiple local format signals or commands compatible with the command protocol of the discrete memory device 104 in response to a single global command. In some embodiments, the discrete memory device 104 may respond to a local command to automatically trigger the issuance of another local command by the command format converter 208.

Data referred to as read data, is read from the selected discrete memory device 104 and provided to the data format converter 210 via the same local I/O ports of memory device interface 204 in the local format. The data format converter 210 then converts the read data from the local format to the global format and provides the read data from the selected discrete memory device 104 to the memory controller through output port GLBCMD_OUT of bridge device interface 202. Bridge device interface 202 includes internal switching circuitry for coupling either the read data from data format converter 210 or the input port GLBCMD_IN to the output port GLBCMD_OUT. The process is reversed when write data is received by the bridge device interface 202 for writing to a selected discrete memory device 104. As will be described later, the data format converter 210 includes memory referred to as a virtual page buffer for temporarily storing this read data and write data.

The read and write data transfer function of the bridge device 200 is summarized as follows. The virtual page buffer stores data, the bridge device interface 202 transfers the data between an external device and the virtual page buffer at a first data rate, and the memory device interface 204 transfers data between a discrete memory device and the virtual page buffer at a second data rate. More specifically for a read operation, the memory device interface 204 receives read data at a first data rate, which is subsequently received and stored by the virtual page buffer. This stored read data in the virtual page buffer is then output via the bridge device interface 202 at a second data rate, which can be different from the first data rate. More specifically for a write operation, the bridge device interface 202 receives write data at first data rate, the virtual page buffer stores the write data received by the bridge device interface 202, and the memory device interface 204 outputs the write data stored in the virtual page buffer at a second data rate.

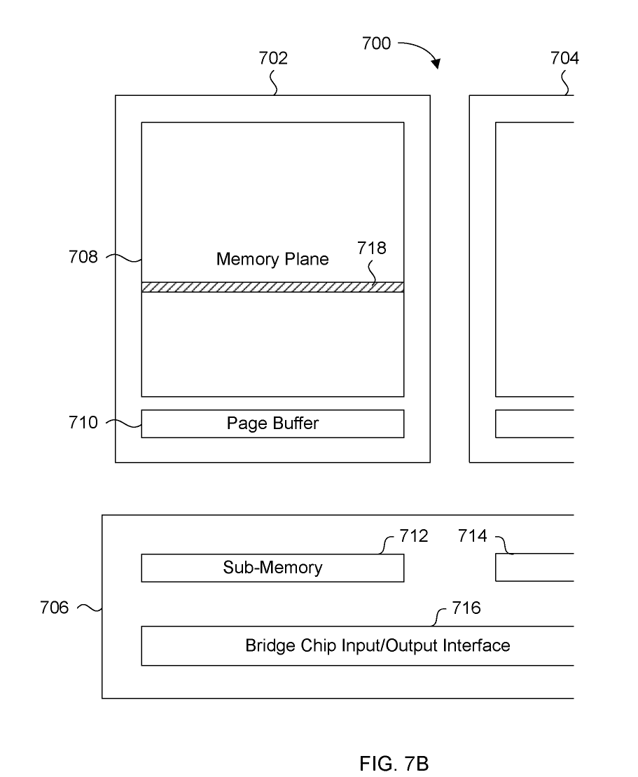

FIG. 5 is a memory system having a plurality of composite memory devices connected in series in a ring topology with a memory controller, according to a present embodiment. In the present example, each of the shown composite memory devices has the architecture shown in FIG. 3A, which can have the bridge device 200 of FIG. 4. Memory system 300 of FIG. 5 is similar to the serial memory system 20 of FIG. 2A. Memory system 300 includes a memory controller 302 and composite memory devices 304-1 to 304-j, where j is an integer number. The individual composite memory devices 304-1±304-j are serially interconnected with the memory controller 302. Similar to system 20 of FIG. 2A, composite memory device 304-1 is the first composite memory device of memory system 300 as it is connected to an output port Sout of memory controller 302, and memory device 304-n is the last device as it is connected to an input port Sin of memory controller 302. Composite memory devices 304-2 to 304-7 are then intervening serially connected memory devices connected between the first and last composite memory devices. The Sout port of memory controller 302 provides a global command and write data in a global format. The Sin port of memory controller 302 receives read data in the global format, and the global command as it propagates through all the composite memory devices.

Each of the composite memory devices shown in FIG. 5 is similar to the composite memory device 100 shown in FIG. 3A. Each of the composite memory devices has a bridge device 102 and four discrete memory devices 104. As was previously described, each bridge device 102 in each of the composite memory device is connected to respective discrete memory devices 104, and to an external device, such as the memory controller 302 and/or a previous or subsequent composite memory device in the serial-ring topology or serial interconnection configuration. The function of each composite memory device 304-1 to 304-j is the same as previously described for the embodiments of FIG. 3A and FIG. 4.

In memory system 300, each composite memory device is assigned a unique global device address. This unique global device address can be stored in a device address register of the bridge device 102, and more specifically in a register of the input/output interface 202 of the bridge device block diagram shown in FIG. 4. This address can be assigned automatically during a power up phase of memory system 300 using a device address assignment scheme, as described in commonly owned U.S. Patent Publication No. 2007/0233917 entitled “APPARATUS AND METHOD FOR ESTABLISHING DEVICE IDENTIFIERS FOR SERIALLY INTERCONNECTED DEVICES”. Furthermore, each composite memory device 304 can include a discrete device register for storing information about the number of discrete memory devices in each composite memory device 304. Thus during the same power up phase of operation, the memory controller can query each discrete device register and record the number of discrete memory devices within each composite memory device. Hence the memory controller can selectively address individual discrete memory devices 104 in each composite memory device 304 of memory system 300.

A description of the operation of memory system 300 follows, using an example where composite memory device 304-3 is to be selected for executing a memory operation. In the present example, memory system 300 is a serially connected memory system similar to the system shown in FIG. 2, and each of the discrete memory devices 104 are assumed to be asynchronous NAND flash memory devices. Therefore the bridge devices 102 in each of the composite memory devices 304-1 to 304-j are designed for receiving global commands in a global format issued by memory controller 302, and converting them into a local format compatible with the NAND flash memory devices. It is further assumed that the memory system has powered up and addresses for each composite memory device have been assigned.

The memory controller 302 issues a global command from its Sout port, which includes a global device address 116 corresponding to composite memory device 304-3. The first composite memory device 304-1 receives the global command, and its bridge device 102 compares its assigned global device address to that in the global command. Because the global device addresses mismatch, bridge device 102 for composite memory device ignores the global command and passes the global command to the input port of composite memory device 304-2. The same action occurs in composite memory device 304-2 since its assigned global device address mismatches the one in the global command. Accordingly, the global command is passed to composite memory device 304-3.

The bridge device 102 of composite memory device 304-3 determines a match between its assigned global device address and the one in the global command. Therefore, bridge device 102 of composite memory device 304-3 proceeds to convert the local memory control signals into the local format compatible with the NAND flash memory devices. The bridge device then sends the converted command to the NAND flash memory device selected by the local device address 118, which is included in the global command. The selected NAND flash device then executes the operation corresponding to the local memory control signals it has received.

While bridge device 102 of composite memory device 304-3 is converting the global command, it passes the global command to the next composite memory device. The remaining composite memory devices ignore the global command, which is eventually received at the Sin port of memory controller 302. If the global command corresponds to a page read operation, the selected NAND flash memory device of composite memory device 304-3 provides page read data to its corresponding bridge device 102 in the local format for temporary storage within bridge device 102. When a global burst read command is received, bridge device 102 then converts the read data into the global format, and passes it through its output port to the next composite memory device. The bridge devices 102 of all the remaining composite memory devices pass the read data to the Sin port of memory controller 302. Those skilled in the art should understand that other global commands may be issued for executing different operations in the NAND flash memory devices, all of which are converted by the bridge device 102 of selected composite memory device 102.

In the present embodiment, the global command is propagated to all the composite memory devices in memory system 300. According to an alternate embodiment, the bridge devices 102 include additional logic for inhibiting the global command from propagating to further composite memory devices in the memory system 300. More specifically, once the selected composite memory device determines that the global device is addressed to it, its corresponding bridge device 102 drives its output ports to a null value, such as a fixed voltage level of VSS or VDD for example. Alternatively, the first word or first several words of the global command may be transmitted and the remainder of the global command is truncated. Therefore, the remaining unselected composite memory devices conserve switching power since they would not execute the global command. Details of such a power saving scheme for a serially connected memory system are described in commonly owned U.S. Patent Publication No. 20080201588 entitled “Apparatus and Method for Producing Identifiers Regardless of Mixed Device Type in a Serial Interconnection”, the contents of which are incorporated by reference in their entirety.

The previously described embodiment of FIG. 5 illustrates a memory system where each composite memory device 304-1 to 304-N having the same type of discrete memory devices therein, such as for example asynchronous NAND flash memory devices. This is referred to as a homogeneous memory system because all the composite memory devices are the same. In alternate embodiments, a heterogeneous memory system is possible, where different composite memory devices have different types of discrete memory devices. For example, some composite memory devices include asynchronous NAND flash memory devices while others can include NOR flash memory devices. In such an alternate embodiment, all the composite memory devices follow the same global format, but internally, each composite memory device has its bridge device 200 designed to convert the global format memory control signals to the local format memory control signals corresponding to the NOR flash memory devices or NAND flash memory devices.

In yet other embodiments, a single composite memory device could have different types of discrete memory devices. For example, a single composite memory device could include two asynchronous NAND flash memory devices and two NOR flash memory devices. This “mixed” or “heterogeneous” composite memory device can follow the same global format described earlier, but internally, its bridge device can be designed to convert the global format memory control signals to the local format memory control signals corresponding to the NAND flash memory devices and the NOR flash memory devices.

Such a bridge device can include one dedicated format converter for each of the NAND flash memory device and the NOR flash memory device, which can be selected by previously described address information provided in the global command. As described with respect to FIG. 3B, the address header 114 includes addressing information used at the system level and the composite memory device level. This additional addressing information includes a global device address (GDA) 116 for selecting a composite memory device to execute an op-code in the memory command, and a local device address (LDA) 118 for selecting a particular discrete device within the selected composite memory device to execute the op-code. The bridge device can have a selector that uses LDA 118 to determine which of the two format converters the global command should be routed to.

The previously described embodiments of the composite memory device show how discrete memory devices responsive to memory control signals of one format can be controlled using global memory control signals having a second and different format. According to an alternate embodiment, the bridge device 200 can be designed to receive global memory control signals having one format, for providing local memory control signals having the same format to the discrete memory devices. In other words, such a composite memory device is configured to receive memory control signals that are used to control the discrete memory devices. Such a configuration allows multiple discrete memory devices to each function as a memory bank operating independently of the other discrete memory device in the composite memory device. Therefore, each discrete memory device can receive its commands from the bridge device 200, and proceed to execute operations substantially in parallel with each other. This is also referred to as concurrent operations. The design of bridge device 200 is therefore simplified, as no command conversion circuitry is required.

The previously described embodiments illustrate how discrete memory devices in a composite memory device can respond to a different command format. This is achieved through the bridge device that converts the received global command into a native command format compatible with the discrete memory devices. By example, a serial synchronous command format can be converted into an asynchronous NAND flash format. The embodiments are not limited to these two formats, as any pair of command formats can be converted from one to the other.

Regardless of the formats being used, an advantage of the composite memory device according to at least some example embodiments, is that each can be operated at a frequency to provide a data throughput that is significantly higher than that of the discrete memory devices within it. Using the composite memory device of FIG. 3A for example, if each discrete memory device 104 is a conventional asynchronous NAND flash memory device, its maximum data rate per pin is about 40 Mbps. However, the bridge device 102 which receives at least one data stream synchronously with a clock, can be configured to operate at a frequency of 166 MHz, resulting in a minimum 333 Mbps data rate per pin. Depending on the process technology being used to manufacture the bridge device 102, the operating frequency can be 200 MHz or higher to realize even higher data rates per pin. Therefore, in a larger system that uses memory system 300 of FIG. 5 to store data, high speed operations can be obtained. An example application is to use memory system 300 as a mass storage medium in a computing system or other application which demands high performance and large storage capacity.

While the data rate mismatch between the discrete memory device and the bridge device can be significant, the presently shown embodiments of bridge device 102 compensates for any level of mismatch. According to a number of example embodiments, bridge device 102 pre-fetches and stores a predetermined amount of page read data from a selected discrete memory device 104 during a page read operation from the corresponding composite memory device 100, and stores the page read data into a virtual page buffer, embodied as memory for example. The page read data is transferred to the bridge device 102 at the maximum data rate for the discrete memory device 104. Once the predetermined amount of page read data is stored in bridge device 102, it can be outputted at its maximum data rate without restriction. For a page program or write operation to composite memory device 100, bridge device 102 receives the page program data at its maximum data rate and stores it in the virtual page buffer. Bridge device 102 then transfers the stored page data to the selected discrete memory device 104 at the maximum data rate for the discrete memory device 104. The maximum data rate for reading data from and programming data to the discrete memory device may be standardized or outlined in its documented technical specifications.

FIG. 6 is a block diagram of a composite memory device 500 illustrating the relationship between page buffers of four NAND flash memory devices and the virtual page buffer memory of a bridge device, according to a present embodiment. While this example shows four NAND flash memory devices, any number of NAND flash memory devices can be used. Composite memory device 500 is similar to composite memory device 100 shown in FIG. 3A, and includes four NAND flash memory devices 502 in the example embodiment of FIG. 6, and a bridge device 504. Bridge device 504 is shown as a simplified version of bridge device 200 of FIG. 4, where only the memory of data format converter 210 is shown. The other components of bridge device 200 are omitted from FIG. 6 to simply the schematic. As will be discussed later, memory 506 is logically organized into groups that correspond with the page buffers of each of the four NAND flash memory device 502.

Each NAND flash memory device 502 has a memory array organized as two planes 508 and 510, labeled “Plane 0” and “Plane 1” respectively. While not shown, row circuits drive wordlines that extend horizontally through each of planes 508 and 510, and page buffers 512 and 514 which may include column access and sense circuits, are connected to bitlines that extend vertically through each of planes 508 and 510. The purpose and function of these circuits are well known to those skilled in the art. For any read or write operation, one logical wordline is driven across both planes 508 and 510, meaning that one row address drives the same physical wordline in both planes 508 and 510. In a read operation, the data stored in the memory cells connected to the selected logical wordline are sensed and stored in page buffers 512 and 514. Similarly, write data is stored in page buffers 512 and 514 for programming to the memory cells connected to the selected logical wordline.

The virtual page buffer memory 506 of bridge device 504 is divided into logical or physical sub-memories 516 each having the same storage capacity of a page buffer 512 or 514. In an alternative embodiment, to save die area on bridge device 504, the virtual page buffer memory 506 may have only a fraction of the aggregate capacity of the page buffers 512 and 514 on each of the NAND flash memory devices 502. A logical sub-memory can be an allocated address space in a physical block of memory while a physical sub-memory is a distinctly formed memory having a fixed address space. The sub-memories 516 are grouped into memory banks 518, labeled Bank0 to Bank3, where the sub-memories 516 of a memory bank 518 are associated with only the page buffers of one NAND flash memory device 502. In otherwords, sub-memories 516 of a memory bank 518 are dedicated to respective page buffers 512 and 514 of one NAND flash memory device 502. During a read operation, read data in page buffers 512 and 514 are transferred to sub-memories 516 of the corresponding memory bank 518. During a program operation, write data stored in sub-memories 516 of a memory bank 518 is transferred to the page buffers 512 and 514 of a corresponding NAND flash memory device 502. It is noted that NAND flash memory device 502 can have a single plane, or more than two planes, each with corresponding page buffers. Therefore, memory 506 would be correspondingly organized to have sub-memories dedicated to each page buffer.

The present example of FIG. 6 has NAND flash devices 502 with at total of 8 KB of page buffer space, organized as two separate 4 KB page buffers. Each separate 4 KB page buffer is coupled to the bitlines of a respective plane, such as plane 508 or plane 510 for example. Those skilled in the art understand that page buffer sizes have gradually increased as the overall capacity of NAND flash memory devices has increased, thus future NAND flash devices may have even larger page buffers. The larger page buffers allow for faster overall read and program operations because the core read and program times of the NAND flash memory device is substantially constant, and independent of the page buffer size as is well known to persons skilled in the art. When compared to a page buffer of half the size, a larger page buffer enables a relatively constant burst read of twice as much read data before another core read operation is needed to access another page of data stored in a different row of the memory array. Similarly, twice as much write data can be programmed to the memory array at the same time before another page of write data needs to be loaded into the page buffer. Therefore, larger page buffers are suited for multimedia applications where music or video data can be several pages in size.

In the composite memory device 500 of FIG. 6, the total core page read time includes the NAND flash memory device core page read time, referred to as Tr, plus a transfer time Ttr. The transfer time Ttr is the time required for the NAND flash memory device to output, or read out, the contents of the page buffers 512 and 514 so that they can be written to corresponding sub-memories 516 of one memory bank 518. The total core page program time includes a program transfer time Ttp plus the NAND flash memory device core page program time Tprog. Generally Ttp is the same as Ttr for the same amount of data since bus between bridge device 504 NAND flash memory device 502 operates at the same speed in both directions. The program transfer time Ttp is the time required for the bridge device 508 to output, or read out, the contents of sub-memories 516 of one memory bank 518 so that they can be loaded into corresponding page buffers 512 and 514 of a NAND flash memory device 502 prior to a programming operation. For multimedia applications, the data can be stored across different NAND flash memory devices and concurrently operated to mask core operations of one NAND flash memory device while data corresponding to another NAND flash memory device 502 is being output by bridge device 504. For example, during burst read out of data from one memory bank 518, a core page read operation may already be in progress for loading the sub-memories 516 of another memory bank 518 with data from another NAND flash memory device 502.

There may be applications where the file sizes are smaller than a full page size of a NAND flash memory device page buffer. Such files include text files and other similar types of data files that are commonly used in personal computer desktop applications. Users typically copy such files to Universal Serial Bus (USB) non-volatile storage drives which commonly use NAND flash memory. Another emerging application are solid state drives (SSD) which can replace magnetic hard disk drives (HDD), but use NAND flash memory or other non-volatile memory to store data. The composite memory device read and program sequence is the same as previously described, with the following differences. This example assumes that the desired data is less than a full page size, and is stored in a page with other data. For a read operation, after all the page buffer data has been transferred from page buffers 512 and 514 of a selected NAND flash memory device 502 to corresponding sub-memories 516, a column address is used to define the locations of the first and last bit positions of the desired data stored in sub-memories 516 of the memory bank 518. Then only the first, last and the intervening bits of data are read out from sub-memories 516 of bridge device 504.

The transfer time Ttr in such scenarios may not be acceptable for certain applications due to its significant contribution to the total core read time of the composite memory device. Such applications include SSD where read operations should be performed as fast as possible. While the core read time Tr for NAND flash memory devices remains constant for any page buffer size, the transfer time Ttr for transferring the entire contents to the sub-memories 516 is directly dependent on the page buffer size.

According to a present embodiment, the transfer time Ttr of the composite memory device can be minimized by configuring the sub-memories 516 of a memory bank 518 to have an effective page size, referred to as a virtual page size, that is less than the maximum physical size of the page buffer of a NAND flash memory device within the composite memory device. Based on the virtual page size configuration for a particular memory bank 518, the bridge device 504 issues page read commands where only a segment of data corresponding to the virtual page size stored in the page buffer is transferred to the corresponding sub-memories 516. This segment of the page buffer is referred to as a page segment.

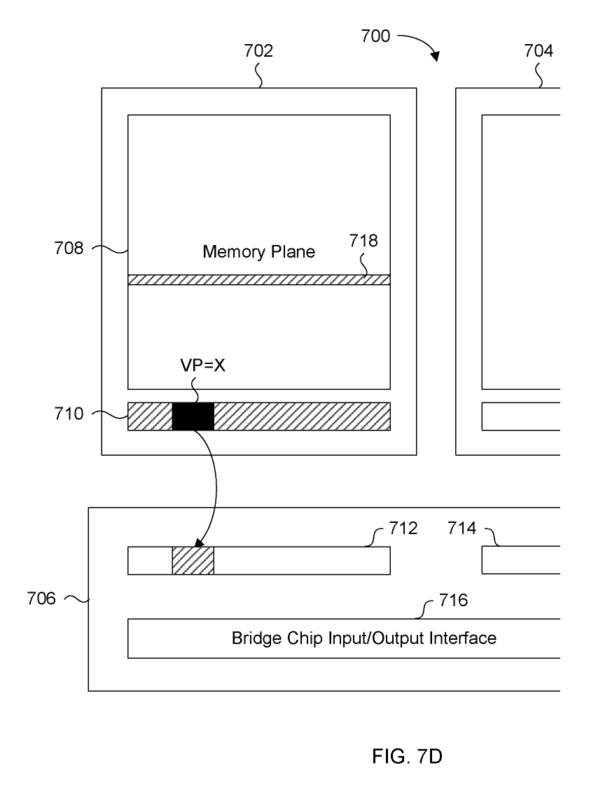

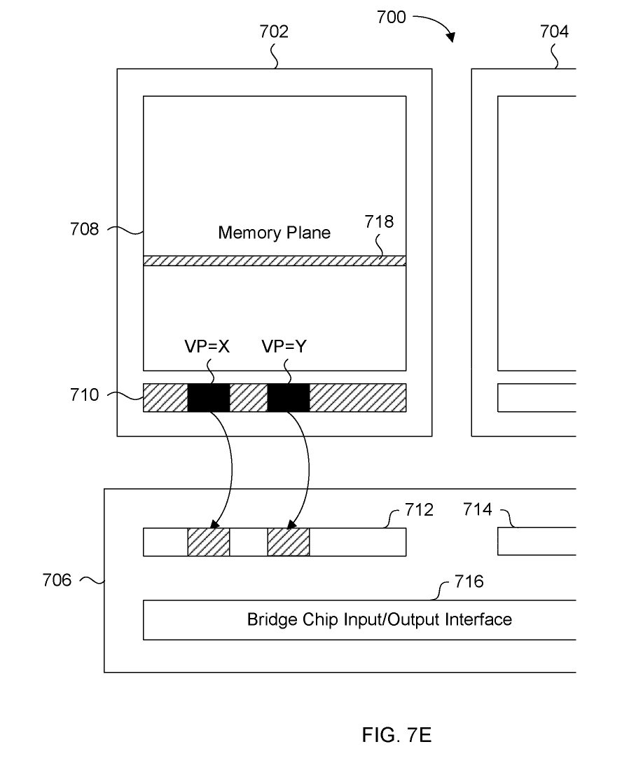

The flow chart of FIG. 7A and FIGS. 7B to 7D illustrates how data corresponding to a set virtual page size is read from a discrete memory device, such as a flash memory device, according to a present embodiment. FIGS. 7B to 7D shows a composite memory device 700 having one fully shown first NAND flash memory device 702, a portion of a second NAND flash memory device 704, and a portion of bridge device 706. The NAND flash memory devices of this example have a single plane 708 having bitlines connected to a single page buffer 710. The shown portion of bridge device 706 includes a first sub-memory 712, a second sub-memory 714, and a bridge device input/output interface 716. First sub-memory 712 corresponds to a first bank, which is associated with first NAND flash memory device 702 while second sub-memory 714 corresponds to a second bank, which is associated with second NAND flash memory device 704. For the purpose of explaining a read operation in the present example, it is assumed that data from first NAND flash memory device 702 is to be accessed, and the virtual page size of the first bank (first sub-memory 712) has been configured to be smaller than the maximum physical size of page buffer 710. For the present discussion, the first and the second sub-memories 712 and 714 are referred to as virtual page buffers.

Following is a description of the method shown in FIG. 7A, with reference to the elements of FIGS. 7B to 7D. In the presently described method of FIG. 7A, it is assumed that one discrete memory device of the composite memory device is selected for reading data therefrom. It is further assumed that the selected discrete memory device has been configured to have a specific virtual page size configuration. The method starts at step 600 where the bridge device receives a global page read command to read data from a specific virtual page (VP) from a physical page (PP) of the selected discrete memory device. In FIG. 7B, it is assumed that bridge device 706 has received global memory control signals corresponding to the global page read command to access data stored in first NAND flash memory device 702. At step 602, if the current read operation is directed to a new PP different from the previous global page read command to the addressed bank, then the method proceeds to step 604. It is assumed for the present example that the current read operation is directed to a new PP. At step 604, the bridge device clears its virtual page buffer 712, which can include setting all their states to the logic “1” or “0” levels, or simply by tagging segments of the virtual page buffer as “empty”. The bridge device then encodes and provides a local page read command to NAND flash memory device 702. The NAND flash memory device 702 receives the local page read command at PP=A, and initiates the internal core read operation. In response to the local memory control signals corresponding to the local page read command, NAND flash memory device 702 activates a row or wordline 718 selected by address information in the local memory control signals.

At step 606 the bridge device then waits for the internal core read time Tr specified for the NAND flash memory device 702 to load its page buffers with the data at PP=A. The activities of the NAND flash memory device 702 during Tr are discussed with reference to FIG. 7C. When the wordline 718 is activated, or driven to a voltage level effective for accessing the stored data of the memory cells connected to it, a current or voltage generated on the bitlines connected to each accessed memory cell is sensed by sense circuitry within page buffer 710. Thus the data states of the accessed memory cells are stored in page buffer 710. Proceeding to step 608 once the core read time Tr has passed, the bridge device issues a local burst data read command to NAND flash memory device 702. As previously discussed, the entire contents of page buffer 710 can be provided to bridge device 706 in response to the local burst data read command. According to the present embodiments, when a virtual page size smaller than the physical page size is set, a segment of the page buffer 710 is provided to bridge device 706. In the present example, it is assumed that a virtual page size has been set in bridge device 706. Therefore, the discrete memory device outputs the data stored in a column address range corresponding to VP=X to the bridge device at step 610, which stores this data into its virtual page buffer 712. As shown in FIG. 7D, NAND flash memory device 702 outputs a page segment of data corresponding to a virtual page VP=X stored within a specific range of bit positions of page buffer 710 to virtual page buffer 712 of bridge device 706 in response to the local burst data read command. This data output process is executed at up to the maximum rated speed or data rate for NAND flash memory device 702.

In step 610 the bridge device also sets a READY flag to indicate to the host system or memory controller that the data stored in the virtual page buffers can now be read out. Returning to step 602, if the current read operation is directed to the same PP of the previous read operation, ie. PP=A, then the method skips to step 608 where the bridge device issues a burst data read command to the discrete memory device. In response the discrete memory device outputs VP=Y as shown in FIG. 7E. In this subsequent read operation no discrete memory device core read operation is required since its page buffer already stores the entire data contents of PP=A, which includes the data corresponding to both VP=X and VP=Y. In this situation, the discrete memory device only needs to output the page segment data stored in a column address range corresponding to VP=Y, which is received and stored in the virtual page buffer of the bridge device at step 608. In response to the set READY flag, the memory controller can issue a global burst data read command to output the data stored in the virtual page buffer. The page read access time for this second page read operation will be faster because no core read time Tr is required, only the transfer time Ttr is necessary.

In the read method embodiment described above, the reading of VP=X and VP=Y from PP=A can occur in sequence. In particular, steps 600 to 610 are executed for reading out VP=X from the composite memory device, followed by another read operation involving only steps 600, 602, 608 and 610 for reading VP=Y. According to an alternate embodiment of the read method shown in FIG. 7A, the second page read command to VP=Y can be issued before the first burst data read command. In this way the transfer of the data corresponding to VP=Y between the discrete memory device and the bridge chip can occur at the same time as data corresponding to VP=X is outputted from the bridge device.

In the presently described example, a burst read command including column addresses corresponding to this specific range of bit positions is provided by bridge device 706 automatically once NAND flash memory device 702 reports or signals to bridge device 706 that the read data from the selected row 718 is stored in page buffer 710, usually by way of a ready/busy signal. The column addresses are determined based on the configured virtual page size for virtual page buffer 712. In response to a global burst data read command, the data stored in virtual page buffer 712 is then output through the output data ports of composite memory device 700 via bridge device input/output interface 716, preferably at a higher speed or data rate.

Therefore it can be seen that by setting a virtual page size for first sub-memory 712 to be less than the maximum physical size of page buffer 710, only a correspondingly sized page segment of data from page buffer 710 is output to first sub-memory 712. This page segment includes the specific range of bit positions, each of which are addressable by a column address. As will be discussed later, the page segment is addressable. Accordingly the transfer time Ttr for the NAND flash memory device 702 to output this page segment of data from page buffer 710 can be significantly reduced relative to the situation where all the data of page buffer 710 is transferred to first sub-memory 712.

The above mentioned example illustrates how the transfer time Ttr can be minimized. Setting the virtual page size to be less than the maximum physical size of page buffer 710 provides the same performance advantage during write operations.

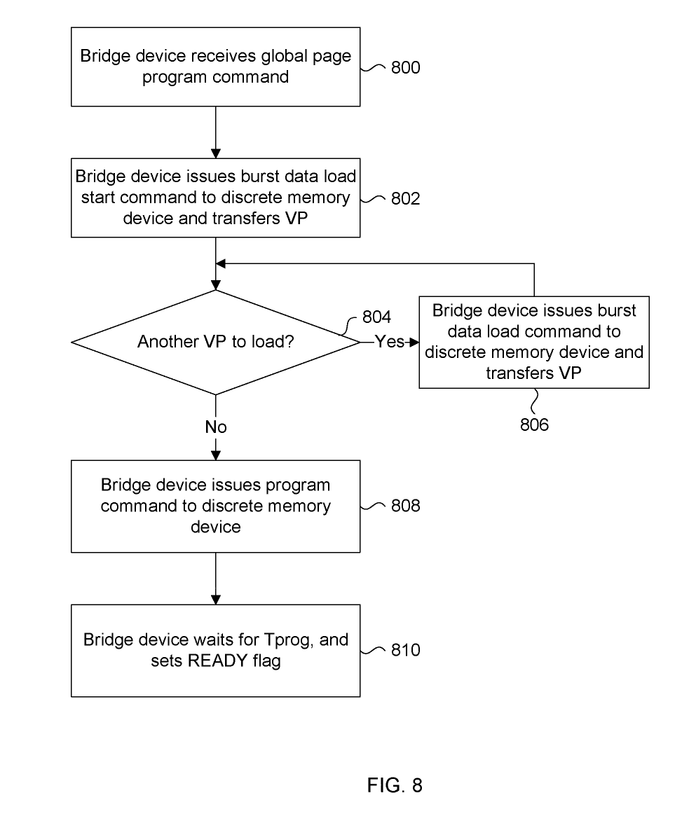

The method for writing data to a composite memory device according to a present embodiment is now described. Generally, the sequence shown in FIGS. 7B to 7E is effectively reversed. In the method of FIG. 8, it is assumed that one particular discrete memory device of the composite memory device is selected for writing data thereto. It is further assumed that the discrete memory device has been configured to have a specific virtual page size configuration. Finally, it is also assumed that the virtual page buffer 712 within bridge device 706 has been previously loaded with data in one or more virtual pages by a global burst data load start command for a first virtual page possibly followed by one or more global burst data load commands for second and subsequent virtual pages. The one or more virtual pages so accessed would be tagged as “written”. The programming method starts at step 800 where a global page program command is received by the bridge device. In this example the data is to be written to PP=A, and the data corresponds to VP=X and VP=Y. In the present example, the write data has a size matching the preset virtual page size.

At step 802 the bridge device issues a burst data load start command to the discrete memory device and then transfers VP=X to the discrete memory device. The time required for transferring this write data from the bridge device 706 to the page buffer 710 is the transfer time Ttr, which depends on the size of the write data and the operating speed of the NAND flash device 702. After time Ttr, the write data is stored within specific bit positions of page buffer 710, referred to as a page segment. Following at step 804, if data corresponding to another virtual page of PP=A is to be written, then the method proceeds to step 806 where the bridge device issues another burst data load command to the discrete memory device. This command transfers data corresponding to another virtual page, such as VP=Y, to the discrete memory device. From step 806, the method loops back to step 804.

If there are no further virtual pages in PP=A to be programmed, then the method proceeds to step 808 where the bridge device issues a program command to the discrete memory device. This initiates core programming operations within the discrete memory device, to program the data such as VP=X and/or VP=Y to PP=A of the discrete memory device. The core programming operation of NAND flash device 702 is initiated through activation of a selected row 718 and the application of the required programming voltages to the bitlines in response to the write data stored in page buffer 710. Program verify operations may also be executed as part of the core programming operation to ensure that the data has been properly programmed. The total core programming time is referred to as Tprog. Following at step 810, the bridge device waits for the core programming time Tprog to pass, and then sets the READY flag, which indicates to the memory controller that the program operation for VP=X and VP=Y to PP=A is complete. Therefore, by shortening the transfer time Ttr during a write operation, the overall write time of the memory system is reduced.

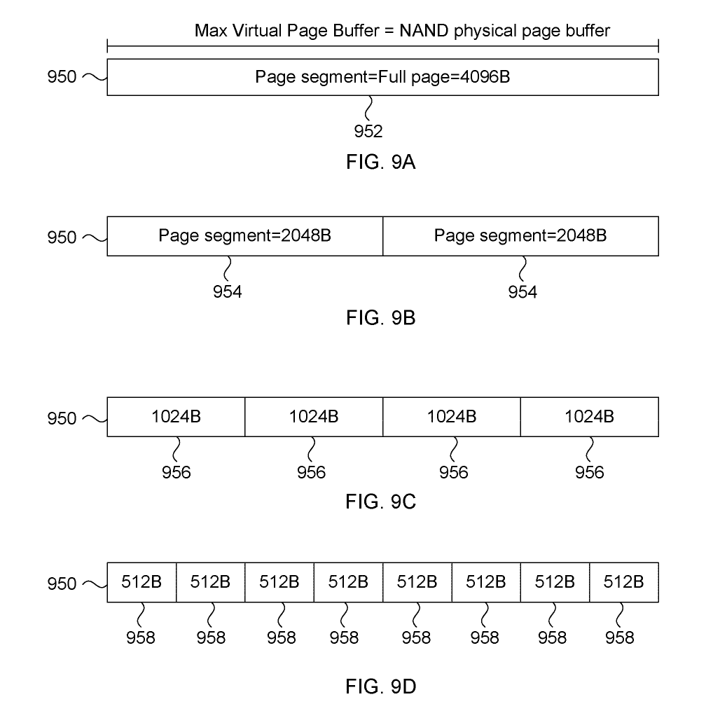

According to the present embodiments, first sub-memory 712 of the bridge device 706 can be dynamically configured to have any one of preset virtual page sizes. Once the virtual page size of first sub-memory 712 is configured, then the page buffer 710 of the corresponding NAND flash memory device is logically subdivided into equal sized page segments corresponding to the configured virtual page size. FIGS. 9A to 9D are schematic representations of a NAND flash memory device page buffer 950 with differently sized page segments based on a configured virtual page size. It is noted that the page segments represent a virtual address space in page buffer 950. In the present examples of FIGS. 9A to D, the NAND flash page buffer, and the sub-memory of the bridge device, both have a maximum 4K physical size. In FIG. 9A, the virtual page size (VPS) is set to the maximum, or full 4K size such that there is only one page segment 952. In FIG. 9B, the VPS is set to 2K, resulting in two 2K page segments 954. In FIG. 9C, the VPS is set to 1 K, resulting in four 1K page segments 956. In FIG. 9D, the VPS is set to 512 bytes (B), resulting in eight page segments 958 each 512 B in size. Those skilled in the art will understand that even smaller sized VPS and corresponding page segments are possible, and that the total number of page segments depends on the maximum size of the NAND flash memory device page buffer 950. In alternate embodiments, the NAND flash devices may also have a spare area associated with each physical page that may not be subdivided in different virtual pages. These areas could be reserved for system use only, and are not accessible to users.

As previously discussed for the present embodiments, after the page buffer 950 of the NAND flash memory device has been loaded with data for a read operation, only page segment of the page buffer 950 is output to the bridge device. The desired data may be stored in one particular page segment of page buffer 950. Therefore each page segment is addressable by a virtual page address provided in the global command to the bridge device. For example, two address bits are used to select one of four page segments 956 in FIG. 9C. Once selected, the desired data may not occupy all bit positions in the selected page segment of page buffer 950. Thus a virtual column address is used to select the first bit position within the selected page segment where read data is to be read out, typically in a global burst read operation. Table 3 below summarizes example addressing schemes based on the example page segments shown in FIGS. 9A to 9D.

TABLE 3

| | | | Bits for addressing |
|---|---|---|---|
| Virtual Page | | Bits for addressing | byte position in each |
| Size | # of Page | Page Segments | Page Segment |
| Configuration | Segments | (VPA) | (VCA) |
| 4096 B | 1 | N/A | 12 |
| 2048 B | 2 | 1 | 11 |
| 1024 B | 4 | 2 | 10 |
| 512 B | 8 | 3 | 9 |

Example addressing schemes are shown in Table 3 by example, but those skilled in the art should understand that different addressing schemes can be used depending on the size of the page buffer of the NAND flash memory device. As shown in Table 3, each addressing scheme includes a first number of bits for addressing two or more page segments, and a second number of bits for addressing a column in the selected page segment. The first number of bits is referred to as a virtual page address (VPA) and the second number of bits is referred to as a virtual column address (VCA). The virtual page address and the virtual column address are collectively referred to simply as a virtual address.

In the present embodiments, the VPS configuration of each sub-memory or bank of sub-memories of the bridge device is known to the memory controller or other host system that requests read data and provides write data to the composite memory device. Therefore a virtual address for reading a corresponding page segment from the page buffer of the NAND flash memory device is provided in the global command to the composite memory device with a corresponding addressing scheme for accessing a particular NAND flash memory device therein. Therefore the virtual address provided in the global command is mapped to real physical addresses usable by the NAND flash memory device, such that a page segment of data can be loaded into or read out of the NAND flash memory device page buffer.

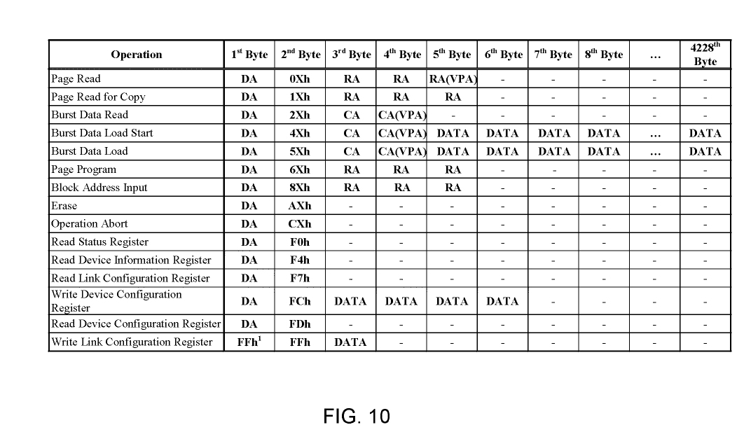

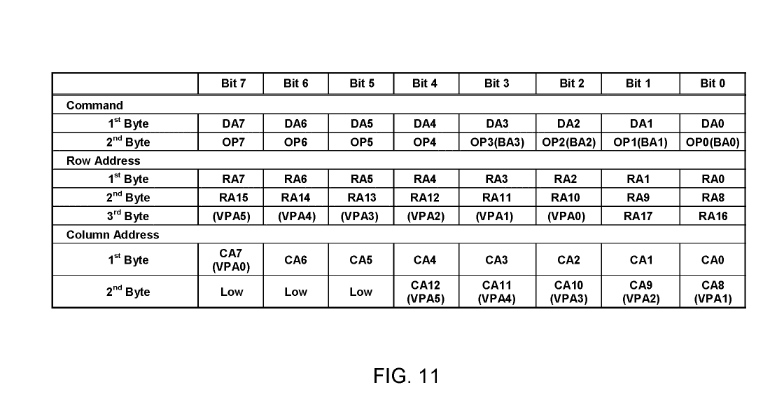

FIG. 10 is a table showing an example command set that the bridge device is configured to respond to. As shown in the left hand column of FIG. 10 titled “Operation”, many different operations can be executed, such as the aforementioned page read, burst data read, burst data load and page program operations described in the flow charts of FIG. 7A and FIG. 8. The columns to the right of the “Operation” column show the types of data that are included for each corresponding operation. For all operations, the first byte received by the bridge device is a device address DA, followed by a second byte that is a hexadecimal op-code corresponding to the operation. The following bytes are either row address (RA), column address (CA), read or write data, and virtual page address (VPA) information. FIG. 11 is a table showing an example detailed mapping of the bits for the command, row address and column address bits for the DA, op-code, row address and column address that may be provided for the commands shown in FIG. 10. In this example, block address bits (BA) are part of the op-code byte, and virtual page address bits (VPA) are provided with a row address or a column address portion of the command. In the present embodiments, the command set for composite devices including a bridge device and multiple NAND flash memory devices shown in FIG. 10 is identical to the command set required for a monolithic NAND flash memory device having a high speed serial interface. This allows composite and monolithic devices to easily coexist within the same system.

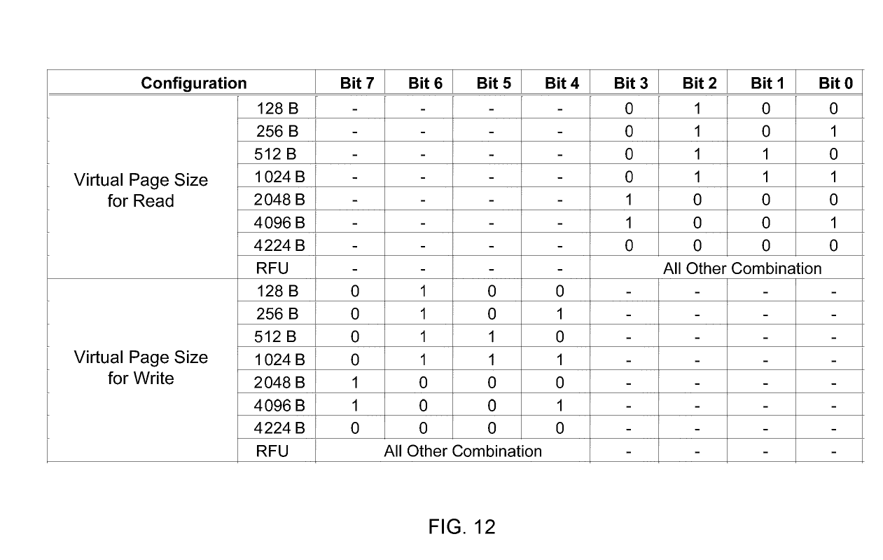

Of note is the Write Device Configuration Register Command, where a configuration register is written to set both read and write virtual page sizes. If the bridge device includes four virtual page buffers, each matched to a discrete memory device, then each virtual page buffer can be independently configured to have a different virtual page size. This allows for user configuration of the virtual page size for any corresponding NAND flash memory device. FIG. 12 is a table showing example states for bits of the configuration register which correspond to different virtual page sizes. In the present embodiments, the virtual page size for read and write operations can be the same or different. One byte is sufficient to configure the virtual page size for read and write operations corresponding to one NAND flash memory device, by combining the desired combination of bits into a single byte. These are referred to as VPS configuration codes. If the virtual page size is to be the same for both read and write operations, then a four bit VPS configuration code is sufficient. Since four bits have been allocated for configuring the virtual page size, 16 virtual page size configurations are possible. Therefore further virtual page sizes greater than 4224 B can be accommodated by the 4 bit code.

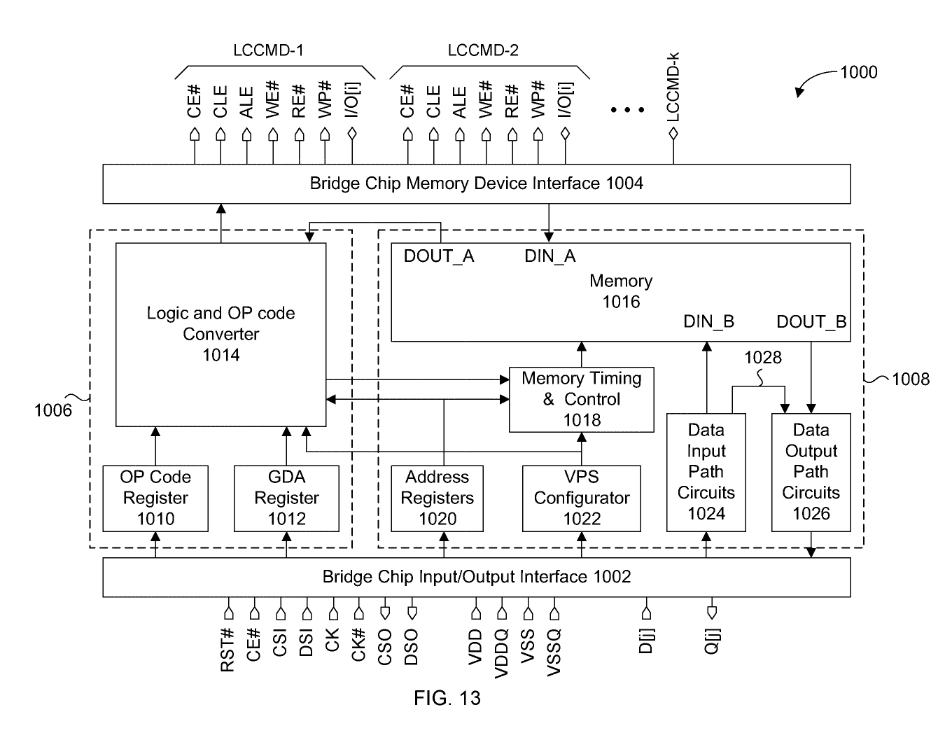

While FIG. 4 generally outlines the functional blocks of bridge device 200, FIG. 13 shows a more detailed block diagram of bridge device 200 in accordance with an example embodiment. Bridge device 1000 includes four main functional blocks, which correspond to those shown for bridge device 200 of FIG. 4. These are the bridge device input/output interface 1002, the memory device interface 1004, the command format converter 1006 and the data format converter 1008. These blocks have functions which correspond to blocks 202, 204, 208 and 210 of FIG. 4 respectively. The embodiment of FIG. 13 is applied to an example where the composite memory device includes conventional NAND flash memory devices, and the composite memory device itself is configured to have a serial interface corresponding to the serial interface flash memory device of FIG. 2B. Following is a detailed description of the blocks 1002, 1004, 1006 and 1008.

The bridge device input/output interface 1002 receives global memory control signals having one format, and passes the received global memory control signals and read data from the discrete memory devices, to subsequent composite memory devices. In the present example, these global memory control signals are the same as the identified memory control signals in FIG. 2B, which are described in Table 2. In relation to FIG. 4 using the present example, the global command GLBCMD_IN includes global memory control signals CSI, DSI and D[j], and the passed global command GLBCMD_OUT includes echo versions of the global memory control signals CSI, DSI and D[j] referred to as CSO, DSO and Q[j] respectively. These memory control signals provide the global commands, such as those shown in FIG. 10. The aforementioned global memory control signals CSI, DSI and D[j] are considered a global command since they are required to enable the bridge device 1000 to execute operations.

The bridge device input/output interface 1002 has input and output ports for receiving the signals previously outlined in Table 2. This block includes well known input buffer circuits, output buffer circuits, drivers, control logic used for controlling the input and output buffer circuits, and routing of required control signals to the command format converter 1006 and routing of different types of data to and from the data format converter 1008. Such types of data include, but are not limited to, address data, read data, program or write data and configuration data for example. The data received at input ports D[j] and provided at output ports Q[j] can be in either the single data rate (SDR) or double data rate (DDR) formats. Those skilled in the art should understand that SDR data is latched on each rising or falling edge of a clock signal, while DDR data is latched on both the rising and falling edges of a clock signal. Hence the input and output buffers include the appropriate SDR or DDR latching circuits. It should be noted that bridge device input/output interface 1002 includes a control signal flow through path that couples the input ports receiving control signals CSI and DSI to corresponding output ports providing echo signals CSO and DSO. Similarly, a data signal flow through path couples the input ports receiving input data stream(s) D[j] to corresponding output ports providing output data stream(s) Q[j]. The output data stream(s) can be either the input data stream(s) received at D[j], or read data provided from a discrete memory device connected to bridge device 1000.

In the present example, bridge device 1000 receives differential clocks CK and CK# in parallel with other bridge devices in the memory system. Optionally, differential clocks CK and CK# are source synchronous clock signals that are provided from the memory controller, such as memory controller 302 of FIG. 5, and passed serially from one composite memory device to another via their respective bridge devices. In such a configuration, bridge device 1000 includes a clock flow through path to couple the differential clocks CK and CK# received at input ports to corresponding output ports (not shown). Commonly owned U.S. Patent Application Publication Number 20090039927 titled “CLOCK MODE DETERMINATION IN A MEMORY SYSTEM” which is incorporated herein by reference, discloses circuits for enabling a serially connected memory device to operate with parallel or source synchronous clocks. Therefore, the techniques taught in U.S. Patent Application Publication Number 20090039927 can be equally applied to the bridge device 1000.

The memory device interface 1004 provides local memory control signals following a native or local format compatible with the discrete memory devices. This format may be different than the format of the global memory control signals. In the present example, memory device interface 1004 has sets of local memory control signals for controlling a corresponding number of conventional NAND flash memory devices, where each set of local memory control signals includes the signals previously outlined in Table 1. In this example and with reference to FIG. 4, each set of local memory control signals provides a local command LCCMD to a corresponding NAND flash memory device in the composite memory device. Therefore, if there are k NAND flash memory devices in the composite memory device, then there are k sets of local commands LCCMD or channels. In FIG. 13 two full sets of local memory control signals are labeled as LCCMD-1 and LCCMD-2, and the last full set of local memory control signals is simply shown as an output port LCCMD-k. These local commands are provided with the proper sequence, logic states and timing that is compatible with the NAND flash memory devices, such that they will execute the operation coded in the local command.

The memory device interface 1004 has output ports for providing the local memory control signals previously outlined in Table 1, and bidirectional data ports I/O[i] for providing write data and receiving read data. While not shown in FIG. 13, the memory device interface 1004 receives a ready/busy signal R/B# from each NAND flash memory device. This status signal is used by logic and op-code converter block 1014 to determine when any one of program, erase and read operations of the corresponding NAND flash device are completed. This block includes well known input buffer circuits, output buffer circuits, drivers and control logic used for controlling the input and output buffer circuits, and routing of data to and from the data format converter 1008. Such types of data include, but are not limited to, address data, read data, and program or write data for example.

The command format converter 1006 includes at least an op-code register 1010, a global device address (GDA) register 1012 and a logic and op-code converter block 1014. The data format converter 1008 includes a memory 1016, a timing control circuit 1018 for memory 1016, address registers 1020, a virtual page size (VPS) configuration circuit 1022, data input path circuitry 1024 and data output path circuitry 1026. First is a detailed description of the command format converter 1006. Memory 1016 functions as the previously described virtual page buffer.

The command format converter 1006 receives the global memory control signals corresponding to a global command, and performs two primary functions. The first is an op-code conversion function to decode the op-codes of the global command and provide local memory control signals in a local command which represents the same operation specified by the global command. This op-code conversion function is executed by internal conversion logic (not shown). For example, if the global command is a request to read data from a particular address location, then the resulting converted local memory control signals would correspond to a read operation from a selected NAND flash memory device. The second primary function is a bridge device control function to generate internal control signals for controlling other circuits of bridge device 1000, in response to the global command. This bridge device control function is provided by an internal state machine (not shown) that is pre-programmed to respond to all the valid global commands. Such conversion logic and state machine logic is well known to those skilled in the art.

The GDA register 1012 stores a predetermined and assigned composite memory device address, referred to as the global device address. This global device address permits a memory controller to select one composite memory device of the plurality of composite memory devices in the memory system to act on the global command that it issues. In otherwords, the two aforementioned primary functions are executed only when the composite memory device is selected. As previously discussed for FIG. 3B, the global command 110 includes a global device address field 116 for selecting a composite memory device for responding to the global memory control signals (GMCS) 112. In the present example, the global command is received as one or more serial bitstreams via data input port D[j], where the global device address is the first part of the global command 110 received by the bridge device 1000. Comparison circuitry (not shown) in the logic and op-code converter block 1014 compares the global device address in global device address field 116 of the global command 110 to the assigned global device address stored in GDA register 1012.

If there is a mismatch between the global device address stored in GDA register 1012 and global device address field 116 of the global command 110, then logic and op-code converter block 1014 ignores the subsequent global memory control signals received by bridge device input/output interface 1002. Otherwise, logic and op-code converter block 1014 latches the op-code in the global command 110 in op-code register 1010. Once latched, this op-code is decoded so that the bridge device control function is executed. For example, the latched op-code is decoded by decoding circuitry within logic and op-code converter block 1014, which then controls routing circuitry within bridge device input/output interface 1002 to direct subsequent bits of the global command 110 to other registers in bridge device 1000. This is required since the global command 110 may include different types of data depending on the operation that is to be executed. In other words, the logic and op-code converter block 1014 will know based on the decoded op-code, the structure of the global command before the bits have arrived at bridge device input/output interface 1002. For example, a read operation includes block, row and column address information which is latched in respective registers. An erase operation on the other hand does not require row and column addresses, and only requires a block address. Accordingly, the corresponding op-code instructs the logic and op-code converter block 1014 the time at which specific types of address data are to arrive at the bridge device input/output interface 1002 so that they can be routed to their respective registers.

Once all the data of the global command 110 has been latched, then conversion circuitry generates the local memory control signals, having the required logic states, sequence and timing which would be used to execute at least one operation in the NAND flash memory device for completing the operation specified by the global command. For any operation accessing a particular physical address location in the NAND flash memory devices, logic and op-code converter block 1014 converts the address data stored in the address registers 1020 for issuance as part of the local command through the I/O[i] ports. As will be described later, some address information provided in the global command is a virtual page address corresponding to a physical address space or page segment in the page buffer of the NAND flash memory device, which is configurable to have a size equal to or less than the maximum physical size of the page buffer. Therefore logic and op-code converter block 1014 includes configurable logic circuits for converting these virtual addresses provided in the global command into addresses compatible with the NAND flash memory device, based on configuration data stored in registers of the VPS configuration circuit 1022. Data to be programmed to the NAND flash memory device is provided by memory 1016. The local device address (LDA) 118 field of global command 110 is used by logic and op-code converter block 1014 to determine which NAND flash memory device is to receive the generated local memory control signals. Therefore, any one set of LCCMD-1 to LCCMD-k are driven with the generated memory control signals in response to a global command 110.

In the present embodiment, memory 1016 is a dual port memory, where each port has a data input port and a data output port. Port A has data input port DIN_A and data output port DOUT_A, while Port B has data input port DIN_B and data output port DOUT_B. Port A is used for transferring data between memory 1016 and the discrete memory device(s) to which it is coupled. Port B on the other hand is used for transferring data between memory 1016 and the D[j] and Q[j] ports of bridge device input/output interface 1002. In the present embodiment, Port A is operated at a first frequency referred to as a memory clock frequency, while Port B is operated at a second frequency referred to as a system clock frequency. The memory clock frequency corresponds to the speed or data rate of the NAND flash memory device, while the system clock frequency corresponds to the speed or data rate of the bridge device input/output interface 1002. Data to be programmed to the NAND flash memory device is read out via DOUT_A of memory 1016 and provided to logic and op-code converter block 1014, which then generates the local memory control signals compatible with the discrete memory device. Read data received from a discrete memory device is written directly to memory 1016 via DIN_A under the control of logic and op-code converter block 1014. Details of how Port B is used is described later. Logic and op-code converter block 1014 includes control logic for controlling timing of the application and decoding of addresses, data sensing and data output and input through ports DOUT_A and DIN_A respectively. If the discrete memory devices operate synchronously with a clock, then this clock would be provided by the logic and op-code converter block 1014. Otherwise, the discrete memory devices operate asynchronously where status or flag signals are provided to the bridge device to signal that it is ready for the next operation.

In either scenario, the global command instructs the logic and op-code converter block 1014 to select a discrete memory device for which the read or write operations are to be executed on, via a set of local memory control signals (LCCMD-1 to LCCMD-k). The local device address (LDA) 118 field of global command 110 is used by logic and op-code converter block 1014 to determine which NAND flash memory device is to receive the generated local memory control signals. Therefore, any one set of LCCMD-1 to LCCMD-k is driven with the generated memory control signals in response to a global command 110. The global command further instructs logic and op-code converter block 1014 to execute the bridge device control function for controlling any required circuits within bridge device 1000 that complement the operation. For example, data input path circuitry 1024 is controlled during a write operation to load or write the data received at D[j] into memory 1016, before the local memory control signals are generated.

The latched op-code can enable the op-code conversion function for generating the local memory control signals in a local command. There may be valid op-codes which do not require any NAND flash memory operations, and are thus restricted to controlling operations of bridge device 1000. When a read or write operation to the NAND flash memories is requested, logic and op-code converter block 1014 controls memory timing and control circuit 1018, which in turn controls the timing for writing or reading data from a location in memory 1016 based on addresses stored in address registers 1020. Further details of these circuits now follows.

The data format converter 1008 temporarily stores write data received from the bridge device input/output interface 1002 to be programmed into the NAND flash memory devices, and temporarily stores read data received from the NAND flash memory devices to be output from bridge device input/output interface 1002. This read data and write data is stored in memory 1016. Memory 1016 is functionally shown as a single block, but can be logically or physically divided into sub-divisions such as banks, planes or arrays, where each bank, plane or array is matched to a NAND flash memory device. More specifically, each bank, plane or array is dedicated to receiving read data from a page buffer or providing write data to the page buffer, of one NAND flash memory device. Memory 1016 can be any memory, such as SRAM for example. Because different types of memory may have different timing and other protocol requirements, timing control circuit 1018 is provided to ensure proper operation of memory 1016 based on the design specifications of memory 1016. For example, timing of the application and decoding of addresses, data sensing and data output and input are controlled by timing control circuit 1018. The addresses, which can include row and column addresses, can be provided from address registers 1020, while write data is provided via data input path circuits 1024 and read data is output via data output path circuits 1026.

The addresses received from address registers 1020 are used to access a physical address space in memory 1016 that corresponds to the virtual address space of the data stored in the page buffer of the NAND flash memory device. Thus any virtual page address is converted by logic circuitry within timing control circuit 1018 into a corresponding physical addresses. This logic circuitry is configurable to adjust the conversion based on configuration data stored in registers of VPS configuration circuit 1022 because the virtual address space is configurable in size. Therefore in one embodiment, the proper data corresponding to the virtual page or pages stored in memory 1016 can be output from the bridge device 1000 by providing a corresponding virtual page address, which is then converted or mapped to corresponding physical addresses in memory 1016.

Because the virtual address can follow one of several different addressing schemes as previously discussed, the conversion circuitry in logic and op-code converter block 1014, and address decoding circuits in timing control circuit 1018 are configurable to ensure that proper corresponding physical addresses are generated for accessing data both in the page buffer of the NAND flash memory device and the memory 1016. Since the addressing scheme is directly related to the selected virtual page size, the VPS configuration code is used to configure the address conversion circuitry that translates, converts or maps the virtual address into corresponding physical addresses. Persons of skill in the art should understand that adjustable logic functions and decoding circuits are well known in the art. For example, a virtual page address can have a first column mapped to a specific physical column address of the NAND flash memory device page buffer. Then any virtual column address can be mapped as a further offset from this specific physical column address.

According to one embodiment, the virtual address is used for selecting data from the selected page segment of the NAND flash page buffer to be read out. For a read operation, this virtual address is latched so that accesses to the page buffer and the corresponding memory of a bank relating to this read operation are based on this virtual address. This simplifies control over the composite memory device since only one set of address information is provided for the read operation. For example, logic and op-code converter block 1014 uses the VPS configuration code to convert the virtual page address into corresponding address signals for the NAND flash memory device. This same virtual address is translated by conversion logic configured by the VPS configuration code within timing control circuit 1018 to generate the write address of the sub-memory to which the data from the page buffer is to be stored within. The same conversion logic or similar conversion logic converts the virtual address into a read address to read out the data stored from the previous write operation, which is eventually output from the composite memory device.

The data input path circuits 1024 receives input data from input ports D[j], and because the data is received in one or more serial bitstreams switching logic is included for routing, or distributing, the bits to the various registers, such as the op-code register 1010 and address registers 1020. Other registers (not shown) such as data registers or other types of registers, may also receive bits of the input data once the op-code has been decoded for the selected composite memory device. Once distributed to their respective registers, data format conversion circuits (not shown) convert the data which was received in a serial format into a parallel format. Write data latched in the data registers are written to memory 1016 for temporary storage under the control of timing control circuit 1018, and later output to a NAND flash memory device for programming using the proper command format as determined by logic and op-code converter block 1014.

After memory 1016 receives read data from a NAND flash memory device from the I/O[i] ports of one set of local memory control signals, this read data is read out from memory 1016 via DOUT_B and provided to output ports Q[j] via data output path circuits 1026. Data output path circuits 1026 includes parallel to serial conversion circuitry (not shown) for distributing the bits of data onto one or more serial output bitstreams to be output from output ports Q[j]. It is noted that data input path circuits 1024 includes a data flow through path 1028 for providing input data received from the D[j] input ports directly to the data output path circuits 1026, for output on output ports Q[j]. Thus all global commands received at the D[j] input ports are passed through to the Q[j] output ports regardless if the embedded global device address field matches or mismatches the global device address stored in the GDA register 1012. In the serially connected memory system embodiment of FIG. 5, the data flow through path 1028 ensures that every composite memory device 304 receives the global command issued by the memory controller 302. Furthermore, any read data provided by one composite memory device 304 can be passed through any intervening composite memory devices to the memory controller 302.

All the circuits mentioned above that are used for transferring the data between memory 1016 and ports Q[j] and D[j] are operated synchronously with the system clock frequency. In particular, the timing control circuit 1018 includes control logic for controlling timing of the application and decoding of addresses, data sensing and data output and input through ports DOUT_B and DIN_B respectively, in synchronization with the system clock frequency. In some embodiments, this system clock frequency can correspond to the frequency of CK and CK# received by the bridge device input/output interface 1002.

Following is a summary of the operation of bridge device 1000 using an example where a discrete memory device is a NAND flash memory device having a page buffer for storing a page of read data or write data, where a page is well understood to be the data stored in the memory cells activated by a single logical wordline. For example, the page buffer can be 2 K, 4 K or 8 K bytes in size depending on the memory array architecture. During a page read operation where one row is activated, one page of data corresponding to the memory cells of the row are accessed, sensed and stored in the page buffer. If the NAND flash memory device has an I/O width of i=8 bits for example, then the contents of the entire page buffer or a portion of the page buffer are output 8 bits at a time at its maximum rate, to bridge device 1000. Bridge device 1000 then writes the data to memory 1016. Once the data is stored in memory 1016, the data corresponding to the page buffer transferred to memory 1016 is output onto the data output ports Q[j] via the data output path circuits 1026 at the higher data rate. This read operation can be executed in accordance with the method shown in FIG. 7A.

In a write operation, data received from input ports D[j] is written to memory 1016 the maximum data rate of interface 1002. Then all or a portion of the data is read out from memory 1016 and provided to a selected NAND flash memory device 8 bits at a time, at the slower data rate native to the NAND flash memory device. The NAND flash memory device stores the data in its page buffer, and subsequently executes internal programming operations to program the data in the page buffer into a selected row. A program verification algorithm may be executed to validate the correct programmed states of the memory cells, followed by any necessary subsequent program iterations to re-program bits that did not program properly from the previous program iteration. This write operation can be executed in accordance with the method shown in FIG. 8.

While the presently disclosed embodiments show bridge chip input/output interface 1002 receiving and providing data serially, an alternate configuration can have interface 1002 receiving and providing data in a parallel format, similar to the format that asynchronous NAND flash memory devices use where at least one byte of data are transferred at the same time.

As previously mentioned, the virtual page buffers of the bridge device corresponding to a discrete memory device are configurable. With reference to FIG. 13 and according to a present embodiment, each memory bank 518 of memory 506 is independently configurable to have its own virtual page size. In order to configure the memory banks 518 of the bridge device, a global virtual page size configuration command is provided to the composite memory device. This is can be provided just after power up of the system that includes the composite memory device. With reference to the bridge device 1000 of FIG. 13, the VPS configuration command is received at the D[j] input port, and includes VPS configuration code for at least one sub-memory bank, an op-code, and a global device address GDA. As previously discussed, the GDA is used to select the specific composite memory device that is to act on, or execute, the command. The op-code is decoded by logic within Logic and Op-code Converter Block 1014, and the subsequently received virtual page size configuration data is routed by control circuitry within bridge device 1000 to corresponding virtual page registers within VPS configuration circuit 1022.

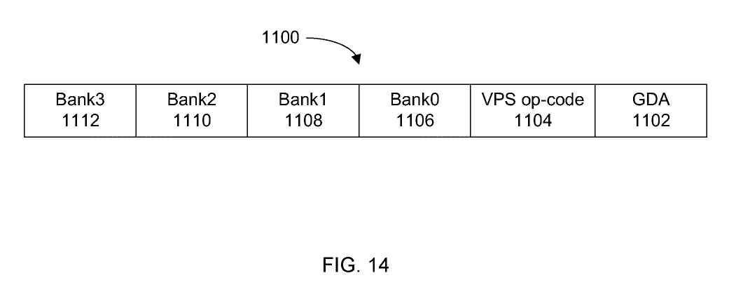

FIG. 14 is a schematic illustrating the hierarchy of a VPS configuration command, according to a present embodiment. Starting from the right side of FIG. 14, the structure of VPS configuration command 1100 includes the previously described GDA field 1102, an op-code field 1104, and in the present example, four VPS data fields 1106, 1108, 1110 and 1112. The GDA field 1102 and the op-code field 1104 can be referred to as a header that precedes the data payload which includes up to the four VPS data fields 1106, 1108, 1110 and 1112. With reference to FIG. 13, the positions of the four VPS data fields corresponds to a specific memory bank 518 of memory 506. In the present example of FIG. 14 applied to memory 506 of FIG. 13, VPS data field 1106 corresponds to Bank0, VPS data field 1108 corresponds to Bank1, VPS data field 1110 corresponds to Bank2, and VPS data field 1112 corresponds to Bank3. Each VPS data field includes a configuration code representing a size for a corresponding virtual page buffer. The presented right to left ordering of the fields of VPS configuration command 1100 represents the order they are provided to bridge device 504. The number of VPS data fields of VPS configuration command 1100 is directly scaled with the number of memory banks 518 of memory 506. For example, if memory 506 is designed to include eight memory banks 518, then VPS configuration command 1100 can include up to a maximum of eight corresponding VPS data fields.

According to a present embodiment, the memory banks 518 of memory 506 are ordered from a least significant bank to a most significant bank. Therefore in the example of FIG. 13, Bank0 is the least significant bank while Bank3 is the most significant bank. As will be described later, the VPS configuration command 1100 has VPS data field structure that follows the ordering of Bank0 to Bank3 to simplify circuitry and logic for configuring memory banks 518. Thus the first VPS data field 1106 adjacent the op-code field is the least significant VPS data field while VPS data field 1112 is the most significant VPS data field. With this ordering scheme, the VPS configuration command 1100 can be dynamically sized depending on the highest significant memory bank 518 that is to be configured. More specifically, only the VPS data fields corresponding to the highest significant memory bank 518 to be configured and all the lower significant banks, are included in VPS configuration command 1100.

According to the present embodiments, VPS configuration command 1100 maintains the same structure regardless of how many banks are to be configured. Thus, any of the data fields can have one of a valid configuration code or a null code indicating that no change to the corresponding virtual page size is required. Alternately, if no change to a corresponding virtual page size is required, then the same code corresponding to the current virtual page size can be provided.

In summary, a composite memory device including discrete memory devices and a bridge device for controlling the discrete memory devices has been described. The bridge device has a virtual page buffer corresponding to each discrete memory device for storing read data from the discrete memory device, or write data from an external device. The virtual page buffer is configurable to have a size up to the maximum physical size of the page buffer of a discrete memory device. The page buffer is logically divided into page segments, where each page segment corresponds in size to the configured virtual page buffer size. By storing read or write data in the virtual page buffer, both the discrete memory device and the external device can operate to provide or receive data at different data rates to maximize the performance of both devices.

The presently described embodiments show how virtual pages are used in a bridge device connected to at least one discrete memory device, and how virtual page sizes for memory banks in the bridge device can be configured. The previously described circuits, command format and methods can be used in any semiconductor device having a memory which has a virtual or logical size configurable to suit application requirements.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention.

It will be understood that when an element is herein referred to as being “connected” or “coupled” to another element, it can be directly connected or coupled to the other element or intervening elements may be present. In contrast, when an element is herein referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Certain adaptations and modifications of the described embodiments can be made. Therefore, the above-discussed embodiments are considered to be illustrative and not restrictive.

What is claimed is:

1. A bridge device, comprising:
a virtual page buffer for storing data;
a bridge device interface for transferring data between an external device and the virtual page buffer at a first data rate in response to a global command; and,
a memory device interface for transferring data between a memory device and the virtual page buffer at a second data rate in response to a local command.

2. The bridge device of claim 1, wherein the memory device includes a page buffer having a fixed maximum size.

3. The bridge device of claim 2, wherein the virtual page buffer is configurable to have a size equal to the fixed maximum size of the page buffer.

4. The bridge device of claim 2, wherein the virtual page buffer is configured to have a size corresponding to a page segment of the page buffer.

5. The bridge device of claim 4, wherein the memory device interface transfers the data corresponding to the page segment between the memory device and the virtual page buffer.

6. The bridge device of claim 4, wherein the global command includes a virtual page address for selecting the page segment of the page buffer.

7. The bridge device of claim 6, wherein the page segment is one of 2ⁿ page segments and the virtual page address is an n-bit address, where n is an integer number of at least 1.

8. The bridge device of claim 6, wherein the global command includes a virtual column address for selecting a bit of the page segment.

9. The bridge device of claim 6, further including a converter circuit for converting the virtual page address into a physical address corresponding to the page segment.

10. The bridge device of claim 9, wherein the converter circuit generates the local command to include the physical address in a format compatible with the memory device.

11. The bridge device of claim 3, wherein the memory device is a first memory device, the virtual page buffer is a first virtual page buffer, and the memory interface is coupled to a second memory device for transferring data between the second memory device and a second virtual page buffer.

12. The bridge device of claim 11, further including a virtual page size configuration circuit for configuring the size of the first virtual page buffer and the second virtual page buffer in response to a virtual page size configuration command.

13. The bridge device of claim 12, wherein the virtual page size configuration command includes an op-code field followed by a first virtual page size data field containing a first configuration code corresponding to the first virtual page buffer, and a second virtual page size data field containing a second configuration code corresponding to the second virtual page buffer.

14. The bridge device of claim 1, wherein the first data rate is greater than the second data rate.

15. The bridge device of claim 1, further including data path circuits for transferring data between the bridge device interface and the virtual page buffer at the first data rate.

16. The bridge device of claim 15, wherein the data path circuits includes a data input path circuit for transferring write data received at the bridge device interface to the virtual page buffer for storage in the virtual page buffer, and a data output path circuit for transferring read data stored in the virtual page buffer to the bridge device interface.

17. The bridge device of claim 16, wherein the virtual page buffer includes a memory having
a first input port for receiving the write data from the data input path circuit,
a first output port for providing the read data to the data output path circuit,
a second input port for receiving the read from the memory device interface, and
a second output port for providing the write data stored in the memory.

18. The bridge device of claim 17, further including a converter circuit for receiving the write data from the second output port of the memory and generating the local command to transfer the write data to the memory device.

19. The bridge device of claim 1, wherein the memory device interface is asynchronous and the bridge device interface is a synchronous interface receiving a clock signal.

20. The bridge device of claim 1, wherein the memory device interface provides the local command in a parallel format, and the bridge device interface receives the global command in a serial format.

21. A bridge device, comprising:
a memory device interface for receiving read data at a first data rate;
a virtual page buffer for storing the read data received by the memory device interface; and,
a bridge device interface for outputting the read data stored in the memory device interface at a second data rate.

22. A bridge device, comprising:
a bridge device input/output interface for receiving write data at first data rate;
a virtual page buffer for storing the write data received by the bridge device interface; and,
a memory device interface for outputting the write data stored in the virtual page buffer at a second data rate.

23. A method for accessing read data from a discrete memory device with a bridge device, comprising:
providing a read address corresponding to the read data to the discrete memory device;
receiving the read data from the discrete memory device;
storing the read data in a virtual page buffer of the bridge device; and,
outputting the read data stored in the virtual page buffer.

24. The method of claim 23, wherein providing includes receiving a global page read command having the read address.

25. The method of claim 24, wherein receiving the global page read command includes issuing a local page read command when the read address corresponds to a new physical page.

26. The method of claim 25, wherein issuing includes execution of a core read operation by the discrete memory device in response to the local page read command to access the read data from the new physical page.

27. The method of claim 26, wherein receiving the read data includes issuing a local burst data read command to the discrete memory device after a core read time for reading the new physical page of the discrete memory device has elapsed.

28. The method of claim 24, wherein receiving the global page read command includes issuing a local burst data read command to the discrete memory device when the read address corresponds to a previously accessed physical page.

29. The method of claim 23, wherein the read address includes a virtual page address corresponding to a page segment of a physical page of the discrete memory device.

30. The method of claim 29, wherein the page segment is one of 2ⁿ page segments and the virtual page address is an n-bit address for selecting the page segment, where n is an integer number of at least 1.

31. The method of claim 30, wherein the read address includes a virtual column address for selecting a bit of the page segment.

32. The method of claim 31, wherein providing the read address includes converting the virtual page address and the virtual column address into a physical address corresponding to the page segment.

33. A method for writing data to a discrete memory device with a bridge device, comprising:
receiving a global page program command;
storing write data to a virtual page buffer of the bridge device;
transferring the write data stored in the virtual page buffer to a discrete memory device; and,
issuing a local program command to the discrete memory device.
